(19) United States
(12) Patent Application Publication
(10) Pub. No.: US 2022/0069637 A1
(43) Pub. Date: Mar. 3, 2022

(54) LOAD LOCALISATION

(71) Applicant: METABOARDS LIMITED, Oxford Oxfordshire (GB)

(72) Inventors: Irina Khromova, Oxford (GB); Christopher Stevens, Oxford (GB); Eleftherios Chatziantoniou, Oxford (GB)

(21) Appl. No.: 17/415,487

(22) PCT Filed: Dec. 20, 2019
(86) PCT No.: PCT/GB2019/053672

§ 371 Date: Jun. 17, 2021

(30) Foreign Application Priority Data
Dec. 20, 2018 (GB) 1820840.5

(51) Int. Cl. H02J 50/90; H04B 5/00; H02J 50/12; H02J 50/60; H02J 50/40

(52) U.S. Cl. CPC H02J 50/90; H04B 5/0037; H02J 50/402; H02J 50/12; H02J 50/60; H04B 5/0075

(57) ABSTRACT

A method of determining a position of an object relative to an array of resonator elements for wireless transmission of power by electromagnetic coupling between adjacent resonator elements is disclosed. The object is inductively coupled to the array. The method comprises determining an input signature of the array with the object coupled thereto, measured at a probe resonator of the array. The method also comprises determining the position of the object relative to the array with reference to the input signature.

### FIELD OF THE INVENTION

The invention relates to locating a load or object that is coupled to an array of resonators capable of supporting wireless power transfer.

### BACKGROUND

It would be convenient to be able to provide power to electronic devices without the need for a wired connection to a fixed power supply. The rapid growth of autonomous devices, such as mobile phones, tablets, laptops, household robots means that such technology is more relevant than ever. Most such autonomous devices are presently battery powered, and charging is often inconvenient. There are significant implications with large batteries, which impact cost and device weight, and which increase device size. A more convenient way of providing electrical power to devices would mitigate the need for large batteries, by improving the ease with which a device can be kept topped-up with charge.

Furthermore, wired connections are potentially clumsy, and require manipulation of a connector fitted to the cable in order to electrically connect a device to a power supply.

Power and connectors are furthermore notorious points of failure for electronic devices, either simply as a result of repeated cycles of connection and disconnection, or as a result of a trip or similar accident imposing a mechanical load on the connector via the cable.

A significant amount of research and development has been undertaken in wireless power transfer. A number of standards exist for wireless power supply, including AirFuel and Qi.

Both systems employ a powered coil in a power transmission unit, and a further receiver coil in the device to be wirelessly powered. Qi systems have a relatively short range, and require relatively close proximity (e.g. 5 mm) inductive coupling between the powered coil and receiver coil.

In AirFuel systems, a resonant inductive coupling between the powered coil and receiver coil is used to transfer power to the target device. The resonant coupling between the powered coil and receiver coil means that power can be transmitted over a greater distance.

EP 2,617,120 discloses wireless energy transfer systems in which repeater resonators are used to transfer power from a source resonator to a target area. At least one of the repeater resonators is detuned according to a routing algorithm.

Although considerable progress in developing wireless power transfer has been made, considerable room for improvement exists. Improvements in the efficiency of wireless power transfer, between chargers and devices, are desirable.

### SUMMARY OF THE INVENTION

According to a first aspect of the disclosure, there is provided a method of determining a position of an object relative to an array of resonator elements for wireless transmission of power by electromagnetic coupling between adjacent resonator elements, wherein the object is inductively and/or capacitively coupled to the array, the method comprising:
determining an input signature of the array with the object coupled thereto, measured at a probe resonator; and
determining the position of the object relative to the array with reference to the input signature.

The input signature may comprise an input impedance spectrum, and/or a time domain reflectometry measurement.

The wireless transmission of power may comprise non-radiative, near field (e.g. reactive) wireless power transmission. The coupling between the object and the array may comprise near field (e.g. reactive) coupling.

The input signature may comprise at least one of: an impedance amplitude and phase, a real and imaginary component of impedance, an impedance magnitude (i.e. magnitude of vector sum of real and imaginary components), a voltage amplitude and/or phase measured in the time domain, and/or a current voltage and/or phase measured in the time domain.

Determining the position of the object relative to the array may be with reference to a comparison between the input signature and stored data obtained from previously measured signatures corresponding with different positions of a test object with respect to the array.

The previously measured signatures may comprise input impedance spectra, or time domain measurements (e.g. time domain reflectometry measurements).

The comparison with previously measured signatures need not be a direct comparison, but may instead be based on information derived from the measured signatures , such as extracted features, or trained filter weights (in the case of a neural network).

The comparison may comprise comparing the input signature with stored signatures corresponding to different positions of the test object with respect to the array. Each stored signatures may comprise a difference signatures, calculated by measuring the signatures with the object in the position and then subtracting an unloaded impedance signature obtained without the object coupled to the array. Comparing the input impedance signature with the stored difference signatures may comprise subtracting the unloaded impedance signatures from the input impedance signature.

The unloaded signature may comprise an input impedance spectra, and/or a time domain measurement of input impedance (e.g. a time domain reflectometry measurement).

An input impedance spectrum comprises a superposition of the unloaded array impedance (without the object) and the reflected impedance of the object. Those components may be quasi-orthogonal, thereby enabling decomposition of the object location from the impedance spectrum.

Comparing the input impedance signature with stored impedance signatures may comprise determining an error or correlation between the input impedance signature and each of the stored impedance signatures.

Determining the error may comprise determining a difference value between the input impedance signature and each of the stored impedance signatures.

Determining the position may comprise identifying the position corresponding with a minimum error. Determining the position may comprise identifying the position corresponding with maximum correlation.

Determining the position of the object relative to the array with reference to the input impedance signature may comprise extracting features from the input impedance signature. The comparison may comprise comparing the features of the input impedance signature with stored features obtained from impedance signatures corresponding to different positions of a test object with respect to the array.

The features of the input signature may comprise an amplitude and/or frequency of at least one of: a local maximum, a global maximum, a local minimum, a global minimum, a point of inflection, and at least one predetermined frequency. The features of the input signature may comprise an amplitude and/or time of at least one of: a local maximum, a global maximum, a local minimum, a global minimum, a point of inflection, and at least one predetermined time.

The predetermined frequencies may correspond with resonant frequencies of magnetoinductive (or electromagnetic) wave modes of the array. The at least one predetermined time may correspond with a reflection of a particular standing wave mode of the array.

The resonators in the array need not each have the same resonant frequency. The array may comprise resonators with dissimilar resonant frequencies. The resonant frequency of elements of the array does not necessarily correspond with a frequency of wireless power transfer from the array to a receiver that is configured to receive power from the array.

The test object may comprise a resonator configured to receive power from the array by inductively coupling with an adjacent resonator of the array.

The magnitude of the inductive coupling coefficient between the test object and the adjacent resonator may be at least 0.025 or at least 0.01. The Q value of each resonator in the array may be between 50 and 1000.

The different positions may comprise, for each resonator element, a position of the test object that is adjacent to the resonator element.

The adjacent resonator element may be the resonator element having the highest coupling coefficient to the test object. The position adjacent to a resonator may be a position that minimises the distance between a centre of the resonator and the centre of the object; or maximises an inductive coupling coefficient between the object and the nearest resonator element (e.g. within a 90% of a maximum).

The different positions may comprise at least one intermediate position between mutually adjacent resonator elements.

An intermediate position may be defined as one in which the magnitude of an inductive coupling coefficient between the test object and a first one of the mutually adjacent resonator elements is within 20% of an inductive coupling coefficient between the test object and a second one of the mutually adjacent resonator elements.

The intermediate positions may comprise positions that are equidistant from two resonators (e.g. on a midpoint of a shared edge of adjacent resonators), three resonators (e.g. in an array of hexagonal resonators), four resonators (e.g. on a corner of a resonator in an array of square resonators, or six resonators (e.g. at a corner of a resonator in an array of triangular resonators).

Determining the position of the object relative to the array with reference to the input impedance signature may comprise using a trained neural network to determine the position of the object from the input impedance signature, wherein the trained neural network has been trained using a plurality of impedance signatures for which the position of a test object is known.

Determining the position of the object relative to the array with reference to the input impedance signature may comprise inverting the input impedance signature using a mathematical model that relates the input impedance signature to the position of the object based (by solving the inverse problem of calculating the position from the measured impedance signature).

At least one resonator element of the array may be a controllable resonator that is switchable from an on state to an off state using a control signal; or is switchable between more than two states of impedance.

Each controllable resonator may comprise a primary resonator, a secondary resonator inductively (and/or capacitively or otherwise) coupled to the primary resonator, and an active control component configured to vary the resistance and/or impedance of the secondary resonator in response to the control signal, thereby adjusting the impedance of the primary resonator.

The coupling between the primary resonator and secondary resonator may result in the coupled system of the primary and secondary resonator having two modes: a first mode in which the currents in the primary and secondary resonator are in phase, and a second mode in which the currents in the primary and secondary resonator are out of phase.

The secondary resonator may be operable in the on state to cause an anti-resonance in the system of the primary resonator and the secondary resonator, at the resonant frequency of the primary resonator.

The input impedance signature may correspond with a first configuration of the array, the method further comprising:
reconfiguring the array into a second configuration and determining a further impedance signature of the element of the array;
wherein determining the position of the object relative to the array is with reference to both the input impedance signature and the further impedance signature.

Reconfiguring the array may comprise adjusting the impedance of at least one of the resonators. Adjusting the impedance may comprise switching at least one controllable resonator to an off state.

The previously measured impedance signatures may correspond with a plurality of configurations of the array.

The object may comprise a plurality of objects, wherein each of the plurality of objects is positioned above a different resonator element of the array.

The method may further comprise, subsequent to determining the position of the object, configuring the array to improve the efficiency of power transfer from a powered resonator element of the array to the object.

Configuring the array to improve the efficiency of power transfer may comprise providing a 1-dimensional waveguide from the powered resonator to a resonator that is adjacent to the object. More than one 1-dimensional waveguide may be provided from the powered resonator to the resonator that is adjacent to the object.

Configuring the array to improve the efficiency of power transfer may comprise turning off a subset of the resonators to suppress one or more standing wave pattern in the array, so as to reduce parasitic losses in resonators that are not participating in power transfer to the receiver.

Configuring the array to provide a 1-dimensional waveguide may comprise switching resonators that are not on the path of the waveguide into an off state. The path may be the shortest path and/or the most efficient path for power transfer.

The array may be configured to support magneto-inductive waves or electro-inductive waves

Each resonator element of the array may be inductively coupled with each adjacent resonator element. Each resonator element of the array may have an coupling coefficient (e.g. an inductive coupling coeeficient) with a magnitude of at least 0.025 or at least 0.01 with each adjacent element of the array.

The object may be a receiver configured to receive wireless power from the array of resonator elements. The receiver may be configured to inductively couple to a resonator element of the array (e.g. with an inductive coupling coefficient having a magnitude of at least 0.01).

The resonant frequency of the resonator elements may be in the range 50 kHz to 400 kHz, or between 1 MHz and 10 MHz, or more than 10 MHz.

The probe resonator may be positioned to avoid a centre (or line) of symmetry of the array.

According to a second aspect, there is provided an apparatus for inductive wireless power transfer, comprising:
an array of resonators in which adjacent resonators are electromagnetically coupled such that they support inter-element excitation waves propagating through the array;
wherein the array of resonators comprises a probe resonator that includes an impedance measurement module for determining an input impedance signature of the array with the object coupled thereto measured at the probe resonator, and
further comprising a processor configured to determine the position of an object that is inductively or capacitively or otherwise coupled to the array from an impedance signature measured by the impedance measurement module.

The inter-element excitation waves may be magnetoinductive waves or electromagnetic waves.

The wireless power transfer may comprise non-radiative, near field (e.g. reactive) wireless power transfer. The coupling between the object and the array may comprise near field coupling.

The impedance measurement module may be configured to measure an impedance spectrum, and/or a time domain impedance measurement (e.g. be configured to perform time domain reflectometry). The signature may comprise an impedance spectrum and/or a time domain impedance measurement.

The apparatus may further comprise a memory that stores data obtained from previously measured input impedance signatures at the probe resonator corresponding with different positions of a test object with respect to the array, wherein determining the position comprises comparing the measured impedance signature with the stored data.

Comparing may comprise correlating the measured impedance signature with the stored data.

The memory may store impedance signatures corresponding with different positions of the test object with respect to the array, and comparing the input impedance signature with previously measured input impedance signatures may comprise determining an error or correlation between the input impedance signature and each of the stored impedance signatures.

Determining the error may comprise determining a difference value between the input impedance signature and each of the stored impedance signatures.

Determining the position may comprise identifying the position corresponding with a minimum error or maximum correlation.

Determining the position of the object relative to the array with reference to the input impedance signature may comprise extracting features from the input impedance signature. The stored data may comprise features obtained from impedance signatures corresponding to different positions of a test object with respect to the array, and the comparison may comprise comparing the features of the input impedance signature with the features of the stored data

The features of the input impedance signature may comprise an amplitude and phase and/or frequency of at least one of: a local maximum, a global maximum, a local minimum, a global minimum, a point of inflection, and at least one predetermined frequency. The features of the input signature may comprise an amplitude and phase and/or time of at least one of: a local maximum, a global maximum, a local minimum, a global minimum, a point of inflection, and at least one predetermined time. In some cases the features of the input signature may comprise an amplitude without a phase.

The at least one predetermined frequency may correspond with frequencies of standing MIW modes of the array (or other wave of inter-element excitation). The at least one predetermined time may correspond with a reflection of a particular standing wave mode of the array.

The test object may comprise a resonator configured to receive power from the array by inductively coupling with an adjacent resonator of the array. Alternatively, the object may be a foreign object that only weakly couples to the array and which may not be specifically designed to receive power from the array. The object may be a book, drinks can, keys, stationary or any other object.

A magnitude of an inductive coupling coefficient between the test object and the adjacent resonator may be at least 0.01 or at least 0.025. A Q of each resonator of the array may be at least 50.

The different positions may comprise, for each resonator element, a position of the test object that is adjacent to the resonator element.

Adjacent may mean the closest resonator element of the array; or with inductive coupling coefficient maximised (within a 80% of a maximum), or the adjacent resonator element be defined as the resonator element having the highest coupling coefficient to the test object.

The different positions may comprise at least one intermediate position between mutually adjacent resonator elements.

The magnitude of an inductive coupling coefficient between the test object and a first of the mutually adjacent resonator elements may be within 20% of an inductive coupling coefficient between the test object and a second of the mutually adjacent resonator elements.

The intermediate positions may comprise positions that are equidistant from two resonators (e.g. on a midpoint of a shared edge of adjacent resonators), three resonators (e.g. in an array of hexagonal resonators), four resonators (e.g. on a corner of a resonator in an array of square resonators, or six resonators (e.g. at a corner of a resonator in an array of triangular resonators).

Determining the position of the object relative to the array with reference to the input impedance signature may comprise using a trained neural network to determine the position of the object from the input impedance signature, wherein the trained neural network has been trained using a plurality of impedance signatures for which the position of a test object is known.

At least one resonator element of the array may be a controllable resonator that is switchable from an on state to an off state using a control signal.

Each controllable resonator may comprise a primary resonator, a secondary resonator inductively coupled to the primary resonator, and an active control component configured to vary the resistance of the secondary resonator in response to the control signal, thereby adjusting the impedance of the primary resonator.

The coupling between the primary resonator and secondary resonator may result in the coupled system of the primary and secondary resonator having two modes: a first mode in which the currents in the primary and secondary resonator are in phase, and a second mode in which the currents in the primary and secondary resonator are out of phase.

The secondary resonator may be operable in the on state to cause an anti-resonance in the system of the primary resonator and the secondary resonator, at the resonant frequency of the primary resonator.

The input impedance signature may correspond with a first configuration of the array, and the processor is configured to:
reconfigure the array into a second configuration by providing a control signal to at least one controllable resonator and determine a further impedance signature of the element of the array;
wherein determining the position of the object relative to the array is with reference to both the input impedance signature and the further impedance signature.

Reconfiguring the array may comprise adjusting the impedance of at least one of the resonators. Adjusting the impedance may comprise switching at least one controllable resonator to an off state.

The previously measured impedance signatures may correspond with a plurality of configurations of the array.

The object may comprise a plurality of objects, wherein each of the plurality of objects is positioned above a different resonator element of the array.

The apparatus may comprise a powered resonator configured to transfer electrical power to the array for wirelessly powering an object adjacent to the array, and the processor is configured to, after determining the position of the object, configure the array to improve the efficiency of power transfer from a the powered resonator element of the array to the object.

Configuring the array to improve power transfer may comprise providing a 1-dimensional waveguide from the powered resonator to a resonator that is adjacent to the object. Configuring the array to improve the efficiency of power transfer may comprise turning off a subset of the resonators to suppress one or more standing wave pattern in the array, so as to reduce parasitic losses in resonators that are not participating in power transfer to the receiver.

Configuring the array to provide a 1-dimensional waveguide may comprise switching resonators that are not on the path of the waveguide into an off state.

The array may be configured to support magneto-inductive waves.

Each resonator element of the array may be inductively coupled with each adjacent resonator element. Each resonator element of the array may have an inductive coupling coefficient with a magnitude of at least 0.01 or at least 0.025 with each adjacent element of the array.

The object may be a receiver configured to receive wireless power from the array of resonator elements. The receiver may be configured to inductively couple to a resonator element of the array.

The resonant frequency of the resonator elements may be in the range 50 kHz to 400 kHz, or between 1 MHz and 10 MHz, or at least 10 MHz.

According to a third aspect, a machine readable non-transitory storage medium is provided, comprising instructions for configuring a processor to perform the method according to the first aspect, including any of the optional features set out above.

The features of each aspect may be combined with those of any other aspect, including the optional features set out above.

According to another aspect, there is provided a method of determining a position of an object relative to an array of resonator elements for wireless transmission of power by electromagnetic coupling between adjacent resonator elements, wherein the object is inductively coupled to the array, the method comprising: measuring a current and/or voltage in each of a plurality of the resonators. The proximity of the object to the array will cause coupling to one or more of the resonator elements of the array. This will manifest itself in a change in the current circulating in the resonator elements that are coupled to the object. By measuring amplitude and/or phase of the current and/or voltage in each or some resonators of the array, it is possible to detect the presence and the position of the object with respect to the array. The measured value or values of current and/or voltage may be reported to a processor or central controller, which subsequently determines the position of the object.

The wireless power transfer may comprise non-radiative, near field (reactive) wireless power transfer. The coupling between the object and the array may comprise near field coupling.

According to another aspect, there is provided a method of determining a position of an object relative to an array of resonator elements for wireless transmission of power by electromagnetic coupling between adjacent resonator elements, wherein the object is inductively or capacitively or otherwise coupled to the array, the method comprising: measuring electrical parameters in the time-domain. for example, performing an electrical time domain reflectometry measurement. The electrical parameter may be input impedance, which will enable determining a position of the object relative to the array by identifying the delay in reflected electromagnetic wave signatures.

The wireless power transfer may comprise non-radiative, near field (e.g. reactive) wireless power transfer. The coupling between the object and the array may comprise near field coupling.

According to a another aspect, there is provided a method of determining a position of an object relative to an array of resonator elements for wireless transmission of power by electromagnetic coupling between adjacent resonator elements, wherein the object is inductively coupled to the array, the method comprising using an additional layer of light sensors, for example photodetectors, that are disposed on a surface of the array. The light sensors may detect the presence of an object above the array and report the coordinates of the affected area to a processor or controller. To operate in conditions of poor illumination, this approach may require additional sources of light operating permanently, in a pulsed more or upon request from a controller.

The light detecting layer may be a separate layer or may be integrated within the main array (e.g. implemented on the same PCB). The light sensor may comprise a photoelectric, photoemission, thermal, polarization, or photochemical light sensor. The light sensor may comprise a photodiode. The light sensor may be a passive device or an active sensing device.

The light sensor may comprise a plurality of light sensors. The light sensors may be distributed on the array. The light sensor may detect light in the visible, infra-red, or ultra-violet regions of the electromagnetic spectrum. In some embodiments, the light sensor may be embedded in the surface of the transmitter. The light sensor may detector ambient light. When the object is placed on or in close proximity to the transmitter, the object may cast a complete or partial shadow on the light sensor.

The wireless power transfer may comprise non-radiative, near field (e.g. reactive) wireless power transfer. The coupling between the object and the array may comprise near field coupling.

According to another aspect, there is provided a method of determining a position of an object relative to an array of resonator elements for wireless transmission of power by electromagnetic coupling between adjacent resonator elements, wherein the object is inductively coupled to the array, comprising using an additional layer of weight/pressure-sensitive material or structure that senses the weight or pressure exerted by the object. The weight or pressure sensitive material may, for example comprise a piezoelectric material, and/or may be disposed above the array. This pressures/weight sensing layer may sense the presence of an object above the array and report the coordinates of the affected area to the a processor of controller.

The wireless power transfer may comprise non-radiative, near field (e.g. reactive) wireless power transfer. The coupling between the object and the array may comprise near field coupling.

According to another aspect of the present disclosure, there is provided a method for locating a target device coupled to an array of resonators, comprising:
conducting a search for the target device by adjusting parameters of the array to vary the distribution of current therein, while monitoring the input impedance of the at least one powered electrical resonator of the array.

The method further may comprise:
categorising the resonators of the array into a plurality of subsets; and
(i) tuning, switching on, and/or connecting all of the resonators in a first subset of the plurality of subsets; and
(ii) detuning, switching off, and/or disconnecting all of the resonators that are not in the first subset;
(iii) measuring the input impedance of the array of resonators;
(iv) determining if the measured input impedance differs from a predetermined value of the input impedance;
(v) determining if the first subset is proximate to the target device based on a difference between the measured input impedance and the predetermined value of the input impedance; and
repeating steps (i)-(v) for each of the other subsets of the plurality of portions.

Each subset may comprise a quadrant and/or there may be four subsets, each comprising substantially one quarter of the elements of the array.

The method may further comprise:
for a subset determined to be proximate to the target device,
(i) tuning, switching on, and/or connecting at least one of the resonators in the portion to provide a first route terminating at a first terminating resonator;
(ii) detuning, switching off, and/or disconnecting all of the resonators that are not in the first route;
(iii) measuring the input impedance of the array of resonators;
(iv) determining if the measured input impedance differs from a predetermined value of the input impedance;
(v) determining if the first route includes the resonator that is closest to the target device based on a difference between the measured input impedance and the predetermined value of the input impedance; and
repeating steps (i)-(v) for at least one route for each possible terminating resonator.

The array of resonators may comprise an A×B array of resonators, where A and B are both odd integers, (such as a 7×5 array of resonators). The array may be powered and the input impedance may be probed at a geometrical-centre resonator. The array may be categorised into four -subsets, wherein each subset comprises an {[(A−1)/2]+1}×{[(B−1)/2]+1} (such as an 4×3 array of resonators in one of the four corner of the 7×5). Each subset may comprise {[(A−1)/2]+1}×{[(B−1)/2]+1} unique terminating resonators (such as twelve unique terminating resonators).

According to another aspect of the present disclosure, there is provided a method for localising a target device coupled to an array of resonators, comprising:
conducting a search for the target device by adjusting parameters of the array to vary the distribution of current therein, while monitoring:
(i) a received power at the target device; and/or
(ii) a received data at the target device.

The target device may be configured to send an indication of receipt of power and/or an indication of receipt of data to the array of resonators. The array of resonators may be configured to receive an indication of receipt of power and/or an indication of receipt of data from the target device. The method may further comprise:
sending from the target device to the array of resonators an indication of receipt of power and/or an indication of receipt of data.

Adjusting parameters of the array may comprise:
(i) selecting a first subset of the resonators of the array;
(ii) tuning, switching on, and/or connecting all of the resonators in the first subset;
(iii) detuning, switching off, and/or disconnecting all of the resonators that are not in the first subset; and
(iv) repeating steps (i) to (iii) for at least a second subset of the resonators of the array, wherein the second subset is different from the first subset.

The array of resonators may be configured to record if the array has received a receipt of power and/or a receipt of data from the target device for the first subset and/or the second subset. The method may further comprise:
recording, by the array of resonators, if the array has received an indication of receipt of power and/or an indication of receipt of data from the target device for the first subset and/or the second subset of resonators.

### BRIEF DESCRIPTION OF THE DRAWINGS

The invention is described in further detail below by way of example and with reference to the accompanying drawings, in which:

FIG. 1 is an apparatus for wireless power transmission comprising a 1D array of power transfer elements, in which current is directly injected at the input element;

FIG. 2 is a system similar to that of FIG. 1, but in which current is provided wirelessly to the input element;

FIG. 3 is a system for wireless power transfer, applied to a coffee table;

FIG. 4 is an equivalent circuit for an input element at which current is directly injected;

FIG. 5 is an equivalent circuit for an input element at which current is excited by inductive coupling with a further resonator;

FIG. 6 is an apparatus for wireless power transfer, applied to the underside of a table, for providing power to target device on top of the table;

FIG. 7 is a generalised equivalent circuit for a controllable element, comprising a primary resonator and a secondary resonator;

FIG. 8 is an equivalent circuit for a specific controllable element, in which a secondary resonator comprises an active element in the form of a transistor;

FIG. 8a is a circuit diagram of an example secondary resonator;

FIG. 9 is a plot of impedance of the primary resonator of a controllable element in an active state (low impedance) and inactive state (high impedance);

FIG. 10 is a system for wireless power transfer comprising a 2D array of elements, in which controllable elements are used to direct magnetoinductive waves to specific locations corresponding with target devices;

FIG. 11 is a schematic illustration illustrating how characteristic parameters measured at input and/or output ports of a resonator array may be used to determine the location of an object;

FIG. 12 is schematic of 7×5 array of resonators, with a powered resonator #8, and an object adjacent to resonator #17;

FIG. 13 is an input signature comprising an impedance spectrum obtained by measuring input impedance at resonator #2 in the array of FIG. 12 with a receiver adjacent to resonator #4;

FIG. 14 is an input signature comprising a impedance spectrum obtained by measuring input impedance at resonator #2 in the array of FIG. 12 with a receiver adjacent to resonator #23;

FIG. 15 is a map of signatures comprising impedance spectra obtained for the array of FIG. 12 with the input impedance spectrum measured at element #2, for each of 35 receiver positions;

FIG. 16 is an input signature comprising an impedance spectrum obtained by measuring input impedance at resonator #2 in the array of FIG. 12 with a no receiver coupled to the array, and with element #7 not present;

FIG. 17 is an input signature comprising an impedance spectrum obtained by measuring input impedance at resonator #2 in the array of FIG. 12 with a receiver adjacent to element #7;

FIG. 18 is a schematic of a method according to an embodiment in which the measured signature is compared to stored signatures;

FIG. 19 is a schematic of a method according to an embodiment in which the features extracted from the measured signature are compared to stored features extracted from previously measured signatures;

FIG. 20 illustrates central positions for which input signatures may be determined;

FIG. 21 is a map of input signatures comprising impedance spectra for each of the positions shown in FIG. 20;

FIG. 22 illustrates a more dense set of sampling positions for which input signatures may be determined;

FIG. 23 is a map of input signatures comprising impedance spectra for each of the positions shown in FIG. 22;

FIG. 24 shows an array with an axis of symmetry, and illustrates a method of resolving degeneracy in input signatures in such a case;

FIG. 25 shows an example of a 7×5 array of resonators in which some of the elements are excluded from operation;

FIG. 26 shows 165 stored signatures comprising impedance spectra obtained from different positions of a receiver relative to an array; and

FIGS. 27 to 32 illustrate example test cases in which the receiver/object is located by comparing a measured signature comprising an impedance spectrum with stored signatures comprising impedance spectra.

FIG. 33 shows an example of a 7×5 array of resonators. The array is split into four quasi-quadrants Q1-Q4, and the array is powered and probed at the geometrically-central resonator No. 1, and receivers are positioned at P1 and/or P2.

FIGS. 34a-d shows an example array of resonators, similar or identical to the one shown in FIG. 33, wherein in each figure resonators in a subset (roughly corresponding with a quadrant) of the array is tuned and the other resonators are detuned. The array is powered at resonator ‘o’ and a receiver is positioned proximate ‘x’.

FIGS. 35a-1 shows the example array of resonators shown in FIGS. 34a-d, but the quasi-quadrant tuning is replaced with tuning of a power route. The terminating resonator in each of the power routes shown in FIGS. 35a-1 is unique.

### DETAILED DESCRIPTION OF ILLUSTRATIVE EMBODIMENTS

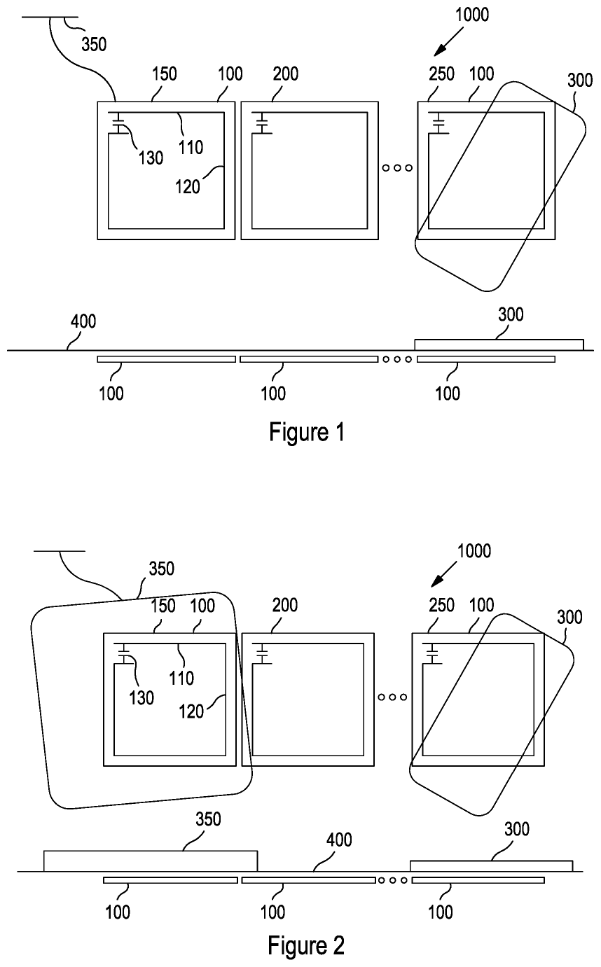

Referring to FIG. 1, an apparatus 1000 for wireless power transmission is shown, comprising an array of elements 100. Each element 100 comprises an electrical resonator 110 comprising a series combination of an inductor 120 (in the form of a conducting loop) and capacitor 130. Each element in the example of FIG. 1 is disposed on a separate substrate or tile, and the tiles are configured such that, when they are placed side-by-side, there is sufficient coupling between the adjacent substrates/tiles to form a medium (or metamaterial) capable of propagating magnetoinductive waves.

In other embodiments the resonators may be defined on a common substrate. In some embodiments there may be capacitive coupling between adjacent resonators, as described, for example in WO2015/033168. In some embodiments there may be conductive coupling between adjacent resonators, for example as described in WO2012/172371. The coupling between adjacent resonators may therefore result from any combination of conductive coupling, inductive coupling and capacitive coupling. In some embodiments, the coupling between adjacent elements is only inductive—this may simplify the construction of the apparatus.

In order to achieve inductive coupling between adjacent elements, the magnitude of the coupling coefficient (defined as the ratio of mutual inductance between adjacent electrical resonators 110 and the geometric mean of the self-inductance of each of the adjacent electrical resonators 110) between adjacent electrical resonators 110 may be at least 0.025. Each resonator 110 may be designed with a resonant frequency that is nominally equal to a system design resonant frequency. A high coupling coefficient between adjacent electrical resonators may be achieved by arranging the conducting loop of each inductor 120 close to the conducting loop of the inductor 120 of an adjacent resonator, for example, within less than 2 mm separation. This may be achieved by placing the inductors side-by-side, by at least partially overlaying inductors on top of each other, and/or by providing different layers of resonators to enhance coupling (e.g. a brick-wall type configuration, with a second layer overlaying a first layer and offset by a half pitch of the resonators).

A sufficiently high degree of coupling may allow the resonators 110 to form a medium capable of propagating magnetoinductive waves so as to transmit power to each of the elements 100, thereby enabling any of the elements to provide wireless power to a proximate target device 30.

Each of the resonators 110 may have an inductor that is matched with the inductor of each of the other resonators (e.g. of the same layout). Each of the resonators 110 may also have a matched capacitance, thereby producing a nominally identical resonant frequency. In other embodiments the array may comprise dissimilar resonators.

Each of the resonators may be designed with a relatively high Q, for example at least 50, at least 100, or at least 200. The Q of a resonator relates to the losses of an oscillating current in the resonator—a greater resistance in the resonator results in higher losses and lower Q. In practice it may be difficult to reduce the effective resistance of the inductor loop. Practical trade-offs between competing design parameters may limit the Q to a few hundred for a practical device.

Power is provided to one of the resonators 100 from an external power supply 350. A resonator that is configured to receive power from the external power supply 350 may be termed a powered resonator 150. The powered resonator 150 may comprise a connector for receiving AC or DC power from an external power supply (in a wired connection), as schematically illustrated in FIG. 1. FIG. 2 illustrates an alternative arrangement in which the external power supply 350 provides wireless (inductively coupled) power to the powered resonator 150.

Intermediate resonators 200 provide a medium for magnetoinductive waves (and hence power) to be transmitted from the powered resonator 150 to an output resonator 250. More generally, in embodiments with conductive and or capacitive coupling, the resonators may provide a medium for the transmission of electromagnetic waves (which term encompasses magnetoinductive waves).

The output resonator 250 is in proximity with a target device 300, which is itself configured to derive power inductively from the oscillating magnetic field of the output resonator 250. The output resonator 250 may be of the same design as the intermediate resonators 200—the term output resonator is merely used to denote a resonator 110 that is providing power to a target device 300. The output resonator 250 may also be termed the target resonator.

Each resonator may have nominally identical design (i.e. matched inductance and capacitance, and therefore matched resonant frequency), but this is not essential (non-identical and non-periodic arrays of resonators are also envisaged). In the example of FIGS. 1 and 2, a one-dimensional array of resonators is illustrated, with the ellipsis denoting ‘n’ further tiles. At the other end of the array, an object or target device 300 is placed in proximity to the output resonator 250. The object 300 in this example may be a mobile phone, but could equally be a laptop, monitor, loudspeaker, lamp, etc. The object 300 receives power by electromagnetic induction from the output resonator 250.

An advantage of a system comprising separate tiles that couple sufficiently strongly to form a medium supporting magnetoinductive (or electromangnetic) waves when placed in a 2D array is that such a system can be used to produce a relatively large area surface that can deliver electrical power to compatible wireless devices that are placed more or less anywhere on the surface. This is illustrated in FIGS. 1 and 2, in which tiles comprising the resonators are placed on the underside of a surface 400 (e.g. of a table or desk), such that any devices 30 placed on the surface 400 can receive wireless power from the resonator 250 nearest to the device 300.

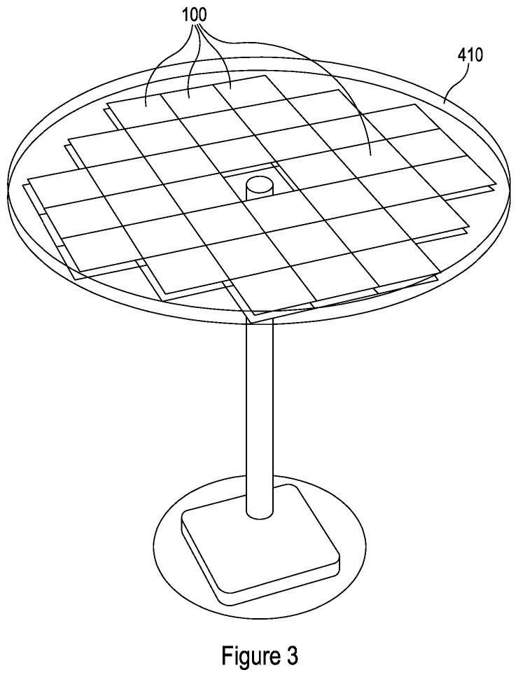

FIG. 3 more clearly illustrates the concept of a table 410 (e.g. coffee table) that is configured as a large area wireless power providing surface using an array of resonators (e.g. tiled resonators). At least some of the resonators in the array would be powered resonators, for example at the edge of the table 410, by which the remaining resonators in the array are energised, such that devices placed on the table surface receive power wirelessly by propagation of magnetoinductive (or electromagnetic) waves through the array of resonators.

Although an example has been described in which each tiles with single resonators are used, this is not essential, and embodiments in which the plurality of resonators are provided on a common substrate are also envisaged.

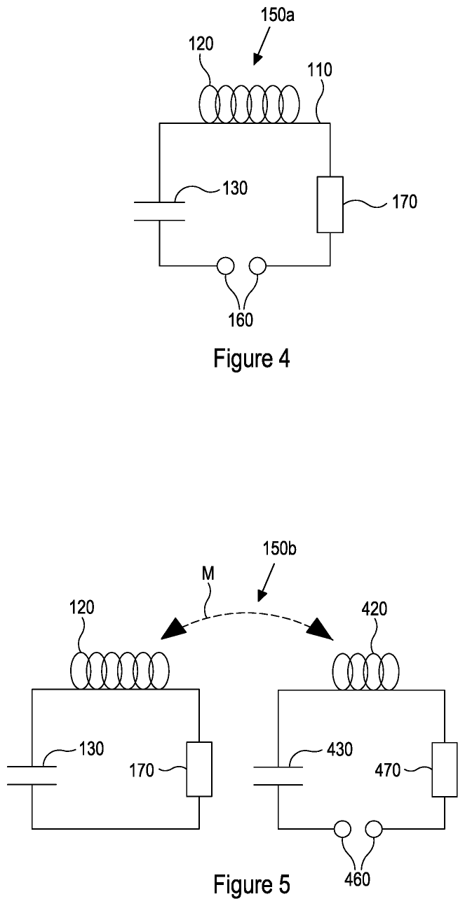

FIG. 4 illustrates an example circuit diagram 150a for a resonator 110 in which current is directly injected. The resonator 110 comprises an inductor 120, capacitor 130, resistance 170 and current injection nodes 160, all connected in series.

For the sake of simplicity in this disclosure, capacitance, resistance and inductance may be depicted as lumped elements, but it will be appreciated that in a real system at least some of these may be distributed (at least to some extent). For instance, a conductor loop may have distributed self-inductance and resistance, and some distributed capacitance with any adjacent conductors (or ground plane).

An powered resonator 150 configured to receive directly injected current may further comprise drive electronics (not shown), which may include an impedance matching network between an AC supply (voltage or current) and the resonator. The powered resonator 150 may further comprise a controller (e.g. processor or microcontroller), and may include control functionality (e.g. software/firmware) for configuring and optimally driving the array of elements coupled (magnetoinductively) thereto. More than one input element may be provided to feed the array with power. This may be appropriate for relatively large arrays (e.g. comprising more than 4, 5, 6, or 10 elements in extent).

FIG. 5 illustrates an alternative circuit diagram 150b for an powered resonator, in which power is provided to the resonator by inductive coupling M with a further resonator (which may be patterned within the resonator, or on the opposite side of the tile to the resonator). The further resonator comprises an inductor 420, capacitor 430, resistance 470 and current injection nodes 460 for injecting current from drive electronics (which may also be provided on the input element 150). An advantage of this indirect drive is that the further resonator may be less constrained in design than the resonator (which should have high Q for efficient power transfer), and the further resonator may be more straightforwardly matched to a drive circuit.

The powered resonator150 may be powered by electromagnetic induction from a power supply 350 (as shown in FIG. 2). The adjacent resonators may be operable to communicate electrical power from a power supply 350 comprising a AlIfuel compliant charging pad to a Airfuel compliant receiver (at the target device 300). This is merely an illustrative example, and the invention does not rely on compliance with a particular standard.

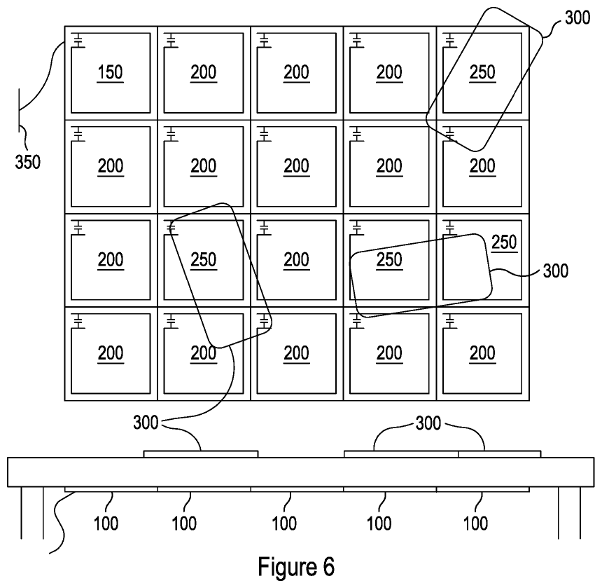

Referring to FIG. 6, an example is shown comprising a two dimensional array of elements 100, each element 100 comprising a resonator. Each element may be provided on a separate tile (or all the elements may be provided on a common substrate). The elements are placed on the underside of a table. The element in the top left of the array comprises a powered resonator 150, which receives power from an external power supply 350, and which feeds the array with a magnetoinductive wave, which propagates through the intermediate resonators 200 to the output resonators 250. The output resonators 250 are those with high inductive coupling with the target devices 300 placed on the table top surface. Each of the output resonators 250 may provide electrical power to a respective target device 300 on top of the table. In this example, there are three target devices 300.

Some embodiments include resonators that are controllable. A controllable resonator comprises means for changing the electrical properties of the resonator, so as to change the degree to which the controllable resonator participates as an element of the magnetoinductive medium. Under some circumstances, more optimal distribution of power through the array may be achieved by effectively disabling some elements of the array (e.g. by giving that resonator a high impedance or low Q at the resonant frequency).

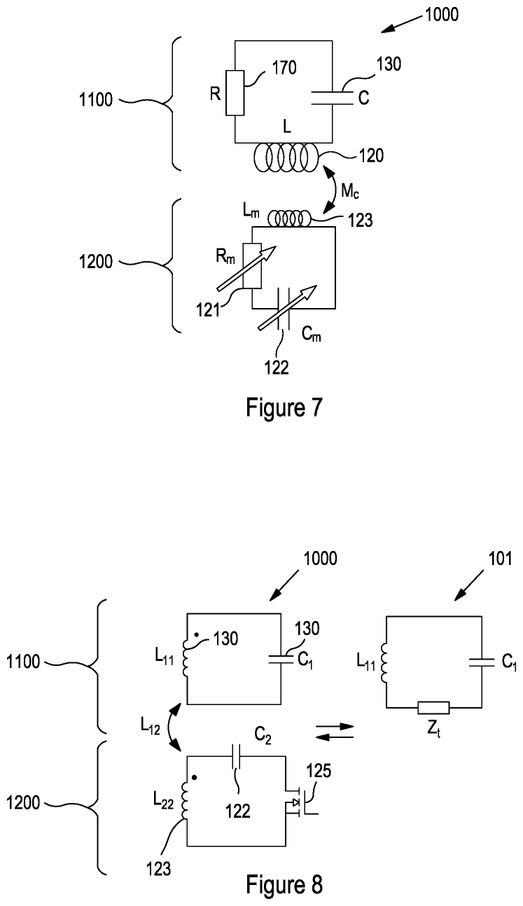

An example of a controllable resonator 1000 is illustrated in FIG. 7. The controllable resonator 1000 comprises a primary resonator 1100 and a control device 1200. The primary resonator 1100 comprises a capacitor 112, inductor 113 and a resistor 111. The control device 1200 comprises a secondary resonator that includes a capacitor 122, resistor 121 and inductor 123. The secondary resonator is inductively coupled to the primary resonator 1100 by the mutual inductance Mc between the inductors 113, 123. The resistor 121 of the secondary resonator is a variable resistor, and the capacitor 122 is a variable capacitor (both responsive to control signals, that are not shown).

Using an inductively coupled control device 1200 avoids the need to interfere with the design of the primary resonator 1100. Adding tuning elements into the primary resonator 1100 may degrade the Q factor thereof, or reduce the mutual coupling between adjacent primary resonators of the waveguide.

Since the secondary resonator 1200 is inductively coupled to the primary resonator 1100, it contributes to the impedance thereof. Varying the resistance and capacitance of the control device 1200 therefore affects the impedance of the primary resonator 1100.

The impedance contribution Z, from the secondary resonator 1200 is given by:

$${Z}_{e} = \frac{{ω}^{2} {M}_{c}^{2}}{{Z}_{m}} \qquad ( 1 )$$

Where Zₘ=Rₘ+j(ωLₘ−1ωCₘ) , and the impedance of the primary resonator Z, is given by:

Zₚ=R+j(ωL−1/ωC)+Zₑ (2)

Several possibilities for the control device 1200 can be considered. Where Rₘ is very large, the contribution Zₑ of the secondary resonator 1200 to the impedance Zₚ of the primary resonator 1100 will be very small. Where Rₘ is small, and LₘCₘ=LC (i.e. the resonant frequencies of the primary and secondary resonators 1100, 1200 are matched), the effect of the secondary resonator will be to cause an anti-resonance (high impedance) in the impedance of the primary resonator 1100 at the resonant frequency w, of the un-coupled primary resonator 1100 (ω_{c}=1/\sqrt{LC}). The coupled system of the primary and secondary resonator 1100, 1200 will have two resonant modes: a first mode in which the currents in the inductors 113, 123 of the primary and secondary resonator are in-phase, and a second in which these currents are out-of-phase. Tuning Rₘ allows the effect of the secondary resonator to be changed. For instance, the effect of a secondary resonator 1200 with matched frequency and a larger Rₘ would be to reduce the Q factor of the resonance of the primary resonator 1100.

Where Rₘ is small, and LₘCₘ≠LC (i.e. the resonant frequencies of the primary and secondary resonators 1100, 1200 are not matched), the effect of the secondary resonator 1200 will be to cause two coupled modes of current oscillation with different frequencies.

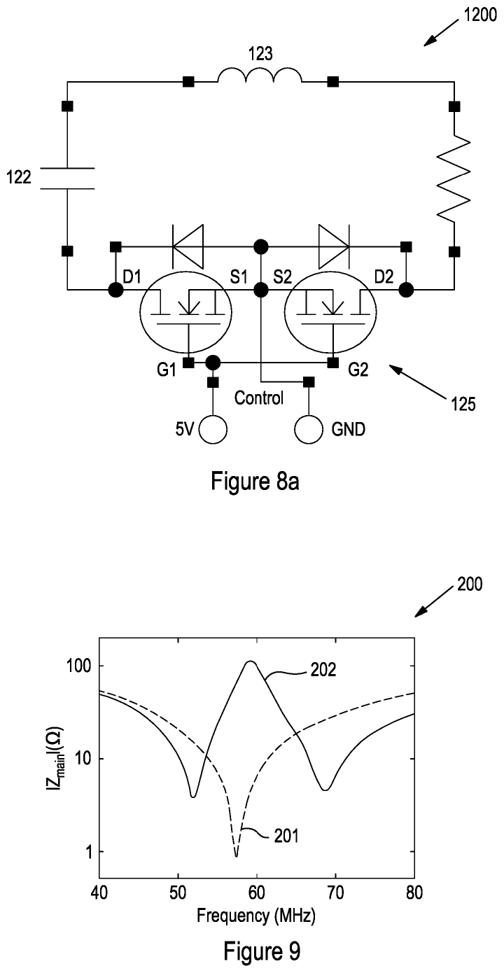

FIG. 8 shows an example of a controllable resonator 1000, similar to that of FIG. 7, in which the control device 1200 includes a secondary resonator. The secondary resonator comprises an active control component 125 for varying the effective resistance thereof. The active control component 125 may comprise a transistor, photodiode or any component that can change resistance in response to a control signal. In FIG. 8 a MOSFET transistor is used at the active control component 125, and the control signal is a voltage applied to the gate of the transistor. When the transistor is in a saturation state, it presents a low resistance, and when in a subthreshold state, a high resistance. The control device 1200 will affect the impedance of the primary resonator 1100 much more when the transistor is in a saturation state that when in subthreshold state. The control signal to the transistor can be thought of as a digital on-off, turning on and off the effect of the control device 1200. Alternatively, the active control component 125 may be operated with a greater resolution, to modulate the effect of the control device 1200 (e.g. by operating the transistor in a saturation mode).

In some embodiments the active control component 125 may comprise a combination of components, FIG. 8a shows an example in which the active control component 125 of the secondary resonator comprises a pair of transistors. The 5V control signal is merely illustrative, and arrangements responsive to other control signals are also envisaged).

Each controllable resonator 1000 may comprise a primary resonator 1100, arranged concentrically with a secondary resonator (or at least with the secondary resonator within the primary resonator). The inductance and resistance of the primary resonator may be provided by a primary loop 114 which is a split-ring resonator. The split is bridged by a capacitance 112. More than one discrete capacitor may be used, which improves matching by averaging any capacitor variation. Each secondary resonator may comprise an active control component 125, in the form a MOSFET transistor. There may be more than one such MOSFET transistor in parallel (which reduces resistance in the saturation state).

Placing the secondary resonator within the primary resonator 1100 has a number of advantages. This arrangement means that the secondary resonator does not affect the spacing or coupling between the primary resonators, while at the same time achieving good inductive coupling between the primary and secondary resonators. Furthermore, any coupling between different secondary resonators will be minimised.

FIG. 9 shows the impedance of a single controllable cell 1000, as shown in FIGS. 7 and 8, in a first state 201 in which the active control component 125 has a high resistance (i.e. the transistors are sub-threshold), and in a second state 202 in which the active control component 125 has a low resistance (i.e. the transistors are saturated). In the first state 201, the primary resonator 1100 has a low impedance of 0.8 ohms at the design frequency 2πω_{c}, which in this case is 57.2 MHz. In the second state 202, the primary resonator 1100 has a high impedance of 66 Ohms at the design frequency. The Q factor in the first state is 80. The change in impedance at the design frequency may be at least a factor of 10 (in this case, a factor on the order of 100 is achieved).

The primary and secondary resonator may be nested square printed copper coils with surface mount capacitors and transistors.

Some or all of the resonators in an array may be controllable elements. A system in which each resonator is controllable provides a maximum degree of flexibility in configuring the array. However, a sufficient degree of control over the propagation of magnetoinductive/electromagnetic waves through the system may be achieved when only a subset of the elements are controllable.

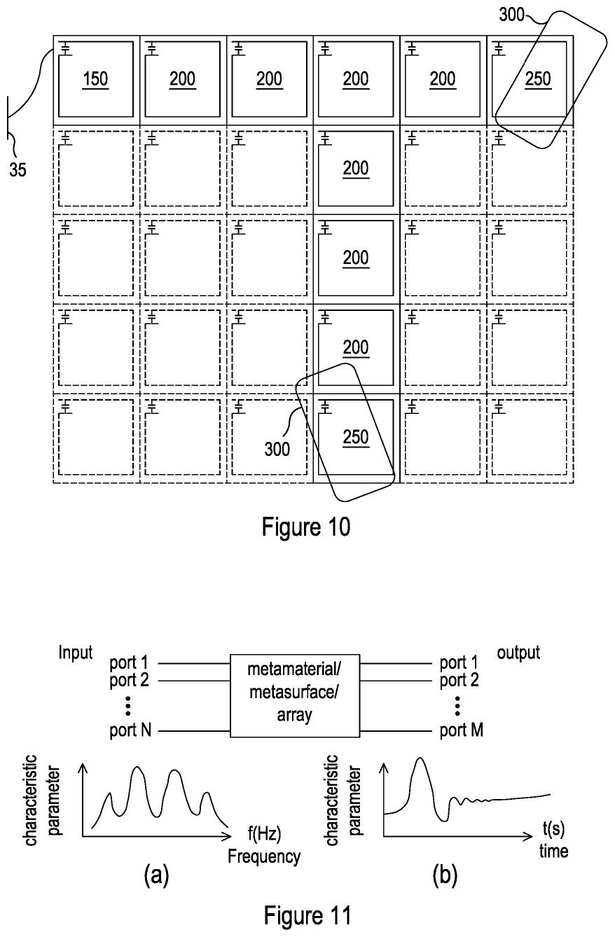

FIG. 10 illustrates an example similar to that of FIG. 6, in which each of the resonators is controllable. A target device 300 is placed at the top right of the array, and a further target device 300 is placed at the bottom edge of the array, four resonators across (and five resonators down) from the powered resonator 150. In order to more efficiently transfer power to the target devices 300, only some resonators 200 of the array (shown in solid lines) may be placed in a high Q state, with low impedance at the system frequency (i.e. the frequency at which the input element injects magnetoinductive waves into the medium formed by the elements). The remaining resonators (shown in broken lines) may be placed into a high impedance state at the system frequency, so that they do not form part of the medium.

At least some resonators may comprise a transmitter and/or receiver. For example, a controllable resonator may comprise a receiver for receiving control instructions, instructing the controllable resonator to vary the impedance of the resonator 11 (e.g. so as to switch the element into and out of coupling with the medium). The transmitter and/or receiver may use wireless signals, or wired connections. Any existing wireless technology may be used to provide wireless communication between tiles, for example ZigBee, Wifi, or Bluetooth.

In order to configure an array of resonators to power an object or target device placed in proximity to the array, it is advantageous to be able to locate the object automatically.

Preferably, any such method for locating the object should add the minimum of cost and complexity to the apparatus.

As illustrated in FIG. 11, an array of resonators (forming a metamaterial for propagation of electromagnetic/magnetoinductive waves) may be considered to be a circuit with N input ports and M output ports. The characteristics of the circuit will be modified by the presence of an object coupled to a resonator of the array. Different positions of the object will modify the electrical properties of the circuit. One way to determine the position of the object is therefore to determine the electrical properties of the array by measuring one or more parameters at one or more input ports, one or more output ports, or any combination of input and output ports.

In the example of graph (a) a characteristic parameter (such as impedance, voltage or some other electrical property) may be measured over a range of frequencies, or over a range of times. The resulting measurement provides a signature, which may be used to identify the position of the object.

An alternative approach is depicted in graph (b), which illustrates that a characteristic parameter (such as current) can be measured over time (e.g. time domain reflectometry). The resulting signal also provides a signature which may be used to identify the position of the object.

One way to determine the position from the measured signature is essentially empirical, by comparison with previously obtained measurements that correspond with known positions of a similar load. An alternative method is to invert the measurement, based on a mathematical model of the array. A further alternative would be to train a machine learning algorithm (such as a convolutional neural network, CNN) with measurements for which the position of the object is known. The trained algorithm (or CNN) can then process measurements to determine the corresponding position of the object.

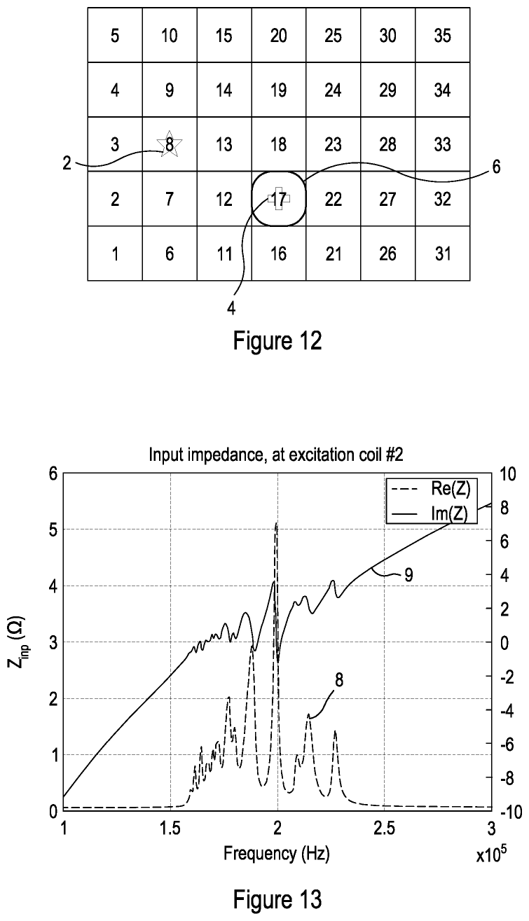

FIG. 12 illustrates an example of an array comprising a 7×5 array of resonator elements.

The array in this example is configured to support magnetoinductive waves, and may include any of the features described above with reference to the preceding figures. The array is excited at element #8, which is indicated in the figure as a ‘star’ shape 2. An object comprising an inductor configured to receive inductive power from the array is positioned above element #17, which is indicated in the figure as a ‘cross’ shape 4, and delineated by a dark outline 6. The object in this example is centrally-aligned with element #17 of the array, rather than being positioned, for example, along an edge of the element or at a corner of the element.

In order to represent an inductor for providing wireless power to charge a phone battery, the receiver includes a 10Ω load connected to the inductor.

The shading of each element in FIG. 12 indicates the level of normalised power dissipated in the resonator of that element. The distribution of power in the resonators depends on the resonant modes of the magnetoinductive waves in the array. A relatively large amount of power is dissipated in resonators other than that of element #17. This results in a low efficiency of power transmission from the powered resonator #8 to the object adjacent to resonator #17: in this case, close to 0%.

The example shown in FIG. 12 demonstrates the need to improve the efficiency of power transmission from an array of resonant elements to a receiver positioned adjacent to a resonator of the array.

One solution to this problem is, firstly, to determine the position of the receiver (the object) with respect to the array, and secondly, to control the elements of the array in order to improve the efficiency of power transmission to the receiver based on the position of the receiver. For example, once the position of the receiver has been identified, the array of resonant elements may be controlled by turning off some of the elements of the array in order to provide a 1D path for the transmission of power from a powered/excited element to the element above which the receiver is positioned (which may be the shortest path, but is not necessarily). Alternatively, constructive interference of MIWs in the array may be used to optimise power transfer. In some embodiments configuring the array to improve the efficiency of power transfer comprises turning off a subset of the resonators to suppress one or more standing wave pattern in the array, so as to reduce parasitic losses in resonators that are not participating in power transfer to the receiver.

Determining the position of the object (receiver) may be achieved by measuring the input impedance at one or more elements of the array. The resonator at which the input impedance is measured may be a different resonator to the powered resonator, or may be the powered resonator.

For example, with reference to FIG. 12, the input impedance may be measured at element #12 (which may be referred to as the probe resonator) in order to locate an object that is inductively coupled the array. There may be a plurality of impedance-probing points. The probe resonator is not necessarily the same as the powered resonator (although it can be). It may be advantageous to position the powered resonator at or near the centre of the array (to minimise power transmission distance), but this may lead to degeneracy for the probe resonator measurements (as more fully discussed below).

The input impedance spectrum obtained from a probe resonator may be different (unique) for each of a plurality of positions of the object (receiver). Examples of input impedance spectra are illustrated in FIGS. 13 to 17. In the examples of FIGS. 13 to 17, the resonators may be designed to transfer power in accordance with the Qi standard, but this is not essential to the invention.

The measured input impedance may comprise a real and imaginary component, which provides information on the relative phase of the current and voltage. Alternatively, the measured impedance spectrum may consist of only the magnitude of the impedance.

As illustrated in the spectra shown in the figures referred to above, the input impedance spectra comprises a series of peaks and troughs. The peaks may represent the modes of standing magnetoinductive waves (MIWs) that are permitted in the array-and-object/receiver system. Features of the spectra, such as peaks, maxima, minima, and points-of-inflection may depend on the location of the object. Also, the amplitude of the features and/or the frequency at which the features occur may depend on the location of the object. Features will also be present in a time domain signature that are characteristic of the modes of standing waves in the array and object/receiver system. Reflections of specific modes may be associated with a particular time delay in a reflectometry measurement.

At certain locations of the object (receiver), some features may be present or may not be present in the input impedance spectrum.

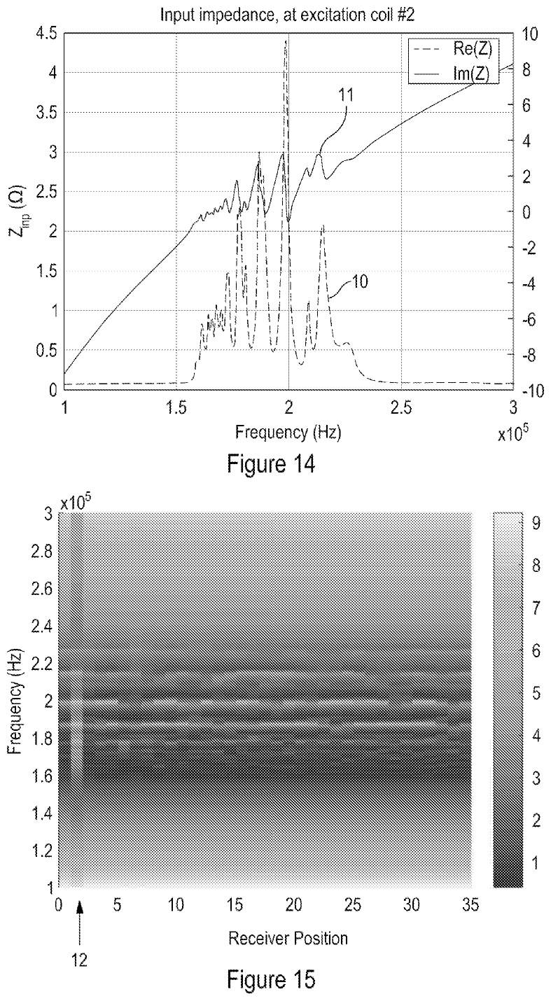

FIGS. 13 and 14 illustrate an input impedance spectrum obtained with the probe resonator and powered resonator as element #2, of a 7×5 array of resonant elements, with a receiver positioned above a resonator element of the array. FIG. 13 is the input impedance spectrum when the receiver is positioned above element #4 of the array, and FIG. 14 is the impedance spectrum when a receiver is positioned above element #23. The two spectra shown in FIGS. 13 and 14 each include the real component (indicated by 8, 10, 14, 16) and the imaginary component (9, 11, 15, 17) of the input impedance as functions of frequency. It can be seen from a simple visible inspection, without the need for a computational analysis, that the two spectra are different. Such differences may be exploited to determine to location of an object or receiver with respect to the array.

FIG. 15 illustrates stored input impedance spectra for a 7×5 array in which the array is powered at element #2 and probed at element #2. For a 7×5 array, there are 35 different elements. Hence, the plot comprises N=35 spectra. Reference numeral 12 indicates the spectrum obtained when the receiver is positioned above resonator #2. Each spectrum corresponds to the receiver being positioned above, and centrally aligned (so as to maximise inductive coupling) with a resonator element of the array. The magnitude (absolute value) of the input impedance is plotted against frequency (y-axis). The numbering of the resonator elements corresponds with the numbering of FIG. 2.

The spectra shown in FIG. 15 corresponds with positions of the object in which the object is aligned with the elements of the array so as to maximise inductive coupling. In practice, the object to be located may not be aligned in this way with a particular element, but may, for example have a similar degree of coupling with two or more resonator elements of the array (for example, when the object is placed at an equal distance from more than one resonator element of the array).

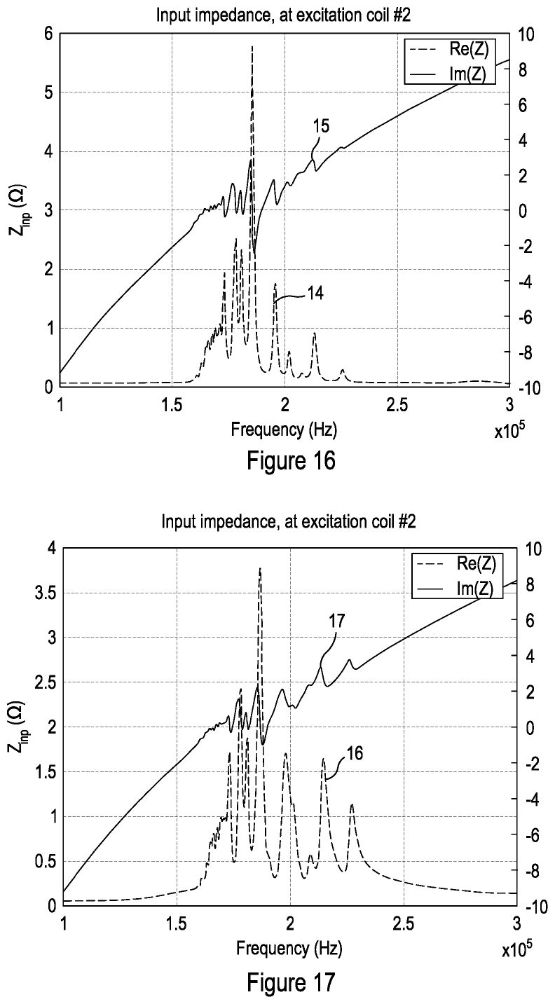

FIG. 16 illustrates an input impedance spectrum corresponding to a 7×5 array probed at element #2 and excited/powered at element #2. Element #7 of the array is not present (omitted from the array). No receiver is coupled to the array.

FIG. 17 illustrates an input impedance spectrum corresponding to a 7×5 array, probed at element #2 and excited/powered at element #2. A receiver is positioned above element #7 of the array (and wherein element #7 of the array is present);

It can be seen from a visual inspection that the two spectra shown in FIG. 16 and FIG. 17 are different. This difference may be exploited to determine if a particular signature or spectrum corresponds to an array with a defect, a faulty element, or a damaged element, or whether a particular signature or spectrum corresponds to an object, a load, a receiver, or a foreign object being positioned above one or more elements of the array. In order to facilitate this, the stored data that the measured impedance data is compared with may comprise measurements obtained with defects in the array, faulty elements and/or foreign objects proximate to the array.

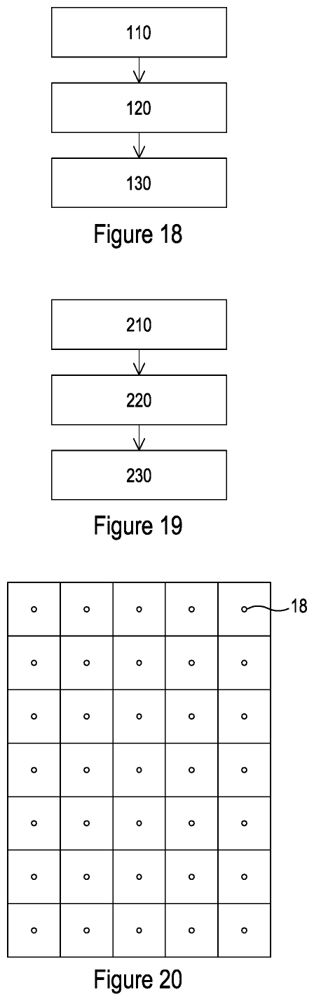

FIG. 18 illustrates an example method of determining the position of an object with respect to an array of transmitter elements which comprises comparing the measured signature with stored signatures corresponding with different positions of a test object. The method comprises steps 110, 120, and 130.

At step 110, an input impedance of a resonator element of the array (which may conveniently be described as the “probe resonator”) is measured at a plurality of frequencies (while the object is positioned proximate to the array) and an input signature is obtained.

At step 120, the input signature is compared with each of plurality of stored signatures corresponding to different positions of the object with respect to the array. Comparing the measured input signature with the stored signatures may comprise determining an error between each of the stored signatures and the measured signature (such as an RMS error). Subsampling of the measured signature may be used to reduce the number of points to be compared. The signature that most closely matches the input signature is identified (which may be the stored signature with the minimum RMS error). In other embodiments, different methods may be used to determine a quality of match between each of the stored signatures and the measured signature, such as correlation.

At step 130, the position of the object is deduced as the position of the receiver associated with the most closely matching stored signature (e.g. the one with the lowest error, or the highest degree of correlation).

The applicant has found that it is possible to locate a receiver placed in one of the 35 positions for which signatures are shown in FIG. 15 using this method of comparing signatures.

An alternative method of determining the position of an object with respect to the array is illustrated in FIG. 19. This method does not require storage of a library of signatures corresponding with known positions of a test object, but instead may rely on features extracted from each signature. In some embodiments the features extracted from the signatures may comprise a compressed version of the signatures obtained by known data compression methods (e.g. wavelet compression). The method comprises steps 210, 220, and 230.

At step 210, the input impedance of a resonator element of the array is measured at a plurality of frequencies (while the object to be located is positioned proximate to the array). The measured signature is processed to obtain a plurality of features. The processing may comprise identifying one or more of at least one of: a local maximum, a local minimum, a point of inflection, a global maximum, and a global minimum. The local maxima of the signature may correspond with different modes of wave propagation in the array. Modes that strongly couple to the location of the object may be most strongly influenced by the array. It is therefore possible to deduce, from the relative amplitudes of local maxima at different frequencies or time delays of the measured signature, the location of the object.

At step 220, the measured extracted features are compared with stored extracted features obtained from impedance signature for each of a plurality of known positions of a test object (representative of the object to be located). The stored feature that most closely matches the feature associated with the measured input signature is identified. Identifying the feature that most closely matches may comprise calculating an error function based on a weighted sum of differences between the features extracted from the measured spectrum and the stored features corresponding with each known position.

At step 230, the position of the object is deduced as the position of the receiver associated with the most closely matching features in the stored features.

A further example method of determining the position of an object with respect to an array of transmitter elements is to train an algorithm (using machine learning) to determine a position from a measured signature. With this approach it is less clear that the measured impedance signature is compared with previously measured signatures corresponding with different positions of a test object. However, the process of training the machine learning algorithm may comprise training the algorithm using measured signature data corresponding with each of a plurality of different positions of a test object. In the case of training a convolutional neural network (CNN), error in the estimated position will be used to adjust the weighting of convolution filters in the layers of the CNN (by back propagation of errors in the CNN). Once the CNN is trained, the weights in the convolution filters can be thought of as information embodying a compressed version of the training data set. Using a CNN to determine the position of the object from the input signature may be advantageous in that it may result in a relatively optimal use of storage, due to the way that the information from the training data set is encoded in the filter weights of the trained CNN. A CNN may also be more tolerant of intermediate positions, and may potentially be faster to execute than a “brute force” approach in which a measured signature must be compared with a very large number of measured signatures (e.g. corresponding with different positions, or permutations of positions of multiple objects, different types of object, different standoffs, etc.)

The techniques disclosed herein can be extended to identify the position of multiple objects that are inductively coupled to the array. For example, the stored data (or the training data set for a CNN) may be extended to include data obtained from permutations of two objects on the array. The best match may subsequently comprise a signature (or features extracted from a signature) corresponding with specific positions of two devices (or more) with respect to the array. The stored data may similarly comprise sets of measured signatures (or features) corresponding with different standoff heights between the object and the array (e.g. representative of a mobile phone placed on a coaster or resting on a book on the surface of the array). The stored data may also comprise different configurations of the array, or different error conditions for the array (such as with foreign objects positioned proximate to one or more resonators).

The methods disclosed herein may be used for determining the position of the receiver loaded with a load that is different from a load of the receiver for obtaining the stored signature. There may be a certain degree of robustness in the determination of the position of the receiver when the load of the receiver is different from the load of the receiver for obtaining the stored signatures. The load of the receiver (for which the position is being determined) may give the most accurate results when it is substantially the same or identical to the load of the receiver for obtaining the stored signature. There may be no need for obtaining stored signatures for a plurality of loads of the receiver. However, obtaining stored signatures for a plurality of loads of the receiver may be advantageous. By obtaining stored signatures a plurality of loads of the receiver, the accuracy with which the receiver position can be determined may be improved. Stored signatures for a plurality of loads of the receiver may be optionally used to determine the load of the receiver. The array may be designed to have an intrinsic impedance (an impedance of an identical infinite array) similar to the target range of load values.

In some examples, the method may facilitate identifying when the object is positioned in an intermediate position (e.g. with a similar degree of inductive coupling to two or more elements of the resonator array). In order to achieve this, measurement data may be obtained from signatures corresponding with known positions of a test object, with the positions including intermediate positions.

The methods disclosed herein for determining the position the object, such as a receiver, may be used to detect the presence and/or position of an object such as a foreign object. The foreign object may be an object that is not specifically configured to receive power from the transmitter array (e.g. not comprising an inductor, and/or having a low inductive coupling coefficient, for example less than 0.025).

The methods disclosed herein may be used to distinguish between a receiver comprising a load positioned above an element of the array (wherein the load is configured to be charged) and a defect in the array (a lattice defect). A defect in the array may, for example, be an element being removed from the array, an element of the array being switched-off, or an element of the array being damaged.

The accuracy of the methods disclosed herein may be affected by several factors. These factors may comprise, but may not be limited to: the number of frequency data points (sampling), the bandwidth, the ‘background’ data, the density of the calibration data, the height of an object above the array, and the value of the load.

The number of frequency data points (the sampling) in each of the stored signatures may influence the accuracy (and/or the precision) of the determination of the position of an object (such as a receiver) relative to the array of resonant elements. It has been found that an accurate (at least to the nearest element of the array) determination of the position of a receiver relative to a 7×5 array may be achieved using only 51 frequency points (in the case where the signature comprises a spectrum).

The frequency bandwidth may also affect the accuracy of the determination of the position of the object. For an array of resonant elements configured to support magneto-inductive waves (MIWs), the optimal frequency bandwidth over which the impedance should be determined to find the location of the object may be a bandwidth that includes (or is the same as) the frequency range for which MIWs are permitted to propagate in the structure.

Another way to improve the accuracy of the determination of the position of the object may be to subtract a reference signature from each of the stored impedance signatures and the input signature.

The number of data points (and/or the density of data points) in the stored signature may also affect the accuracy of the determination of the position of the object.

FIG. 20 illustrates a 7×5 array of resonator elements. The centres 18 of the resonator elements are indicated. Input signatures may be obtained for the object (receiver) being positioned at each of the centre positions indicated.

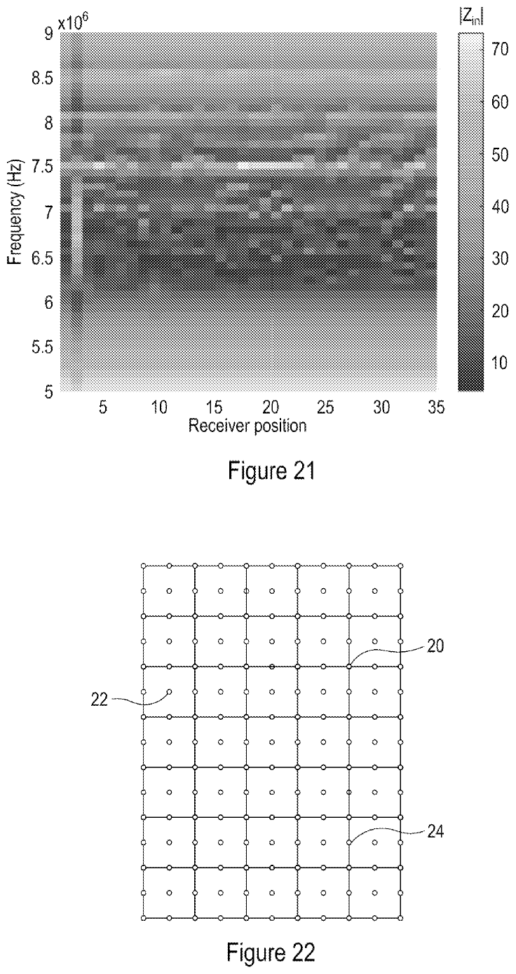

FIG. 21 illustrates the input impedance spectra corresponding to the array shown in FIG. 20. There are N=35 separate spectra. The spectra correspond to the object being positioned at an (x, y) position that is aligned with the centre of a resonator element. Each of the spectra shown in FIG. 21 comprise 51 data points (corresponding to 51 different frequencies) in the 5-9 MHz frequency band.

To improve the accuracy (and/or precision) of the determination of the position of the object, it may be advantageous to increase the number of positions for which stored data (for comparison with the measured impedance spectrum) includes stored signatures or extracted features (or to expand the variety of positions in a training data set for a CNN).

FIG. 22 illustrates a 7×5 array of resonator elements. As well as the centres 22 of the resonator elements being indicated, the centres of the edges 24 and the corners 20 of the resonator elements are also indicated. Stored data, such as stored impedance spectra, or extracted features from impedance spectra (for comparison with a measured impedance spectrum) may be obtained for the object (receiver) being positioned at each of the positions (centres, centres of edges, and corners) indicated.

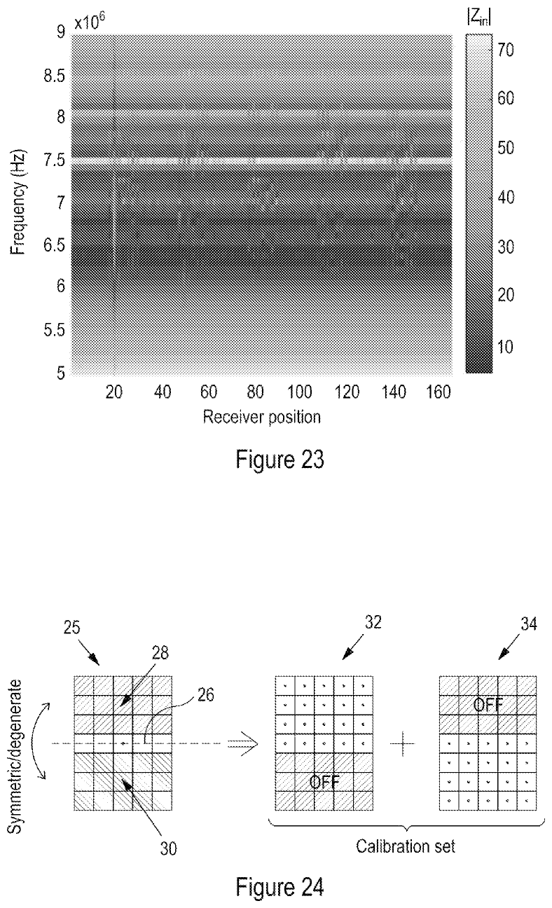

FIG. 23 illustrates the input impedance spectra corresponding to the positions shown in

FIG. 22. There are N=165 separate spectra. The spectra correspond to the object being positioned at an (x, y) position that is aligned with a centre, a centre of an edge, or a corner of a resonator element. Each of the spectra shown in FIG. 23 comprise 51 data points (corresponding to 51 different frequencies) in the 5-9 MHz frequency band.

As well as increasing the number of positions of the receiver for which stored spectra are obtained, the number of frequency data points may be increased to improve accuracy and/or precision. For example, each spectrum may contain more than 50 data points, more than 100 data points, more than 200 data points, or more than 500 data points.

When the input signature is probed at an element of the array that is disposed at a point or line of symmetry (in relation to electromagnetic/magnetoinductive wave propagation), certain positions of the object (or receiver) may be degenerate. Therefore, in some cases, different positions of the receiver may result in input signatures (e.g. spectra) that are essentially identical.

As an example, considering a 7×5 array similar to the one shown in FIG. 12, if the array is excited at element #18 (geometrical centre) and if the input impedance is measured at element #18 also, with a receiver positioned at element #7, the input impedance spectrum that is obtained may be substantially similar to or indistinguishable from input impedance spectra obtained from positioning the receiver at each of elements #9, #27, and #29.

Additional measures may be required to reduce the degeneracy and/or to reduce the symmetry of the system. An example of removing the degeneracy may comprise consecutively disabling at least one selected resonator of the array. In some embodiments, disabling at least one selected resonator may comprise switching a controllable resonator into an off state (as described above).

The selected resonators to be disabled may be chosen in order reduce potential ambiguity in the measurement, for example in order to maximise entropy in the measurements. In some examples, the selected resonators to be disabled may comprise portions of the array that are symmetric with other portions of the array. For example, in the case of an array with fourfold rotational symmetry, ‘quadrants’ of the array may be consecutively disabled, and four signatures (e.g. spectra) obtained measured at the probe resonator. Each of these four impedance signatures be compared with measurement data corresponding with known positions of the object with the resonators in the same state.

Removing or reducing degeneracy by expanding data sets (stored signatures) for symmetrical cases may be important for improving accuracy. FIG. 24 shows an array 25 with an axis of symmetry 26. If the probe resonator lies on this axis 26, impedance spectra obtained for positions in region 28 may be degenerate with spectra obtained for positions in region 30.

To resolve this, stored data may be obtained corresponding with more than one configuration of the array. In a first configuration 32, resonators below the symmetry axis 26 are “switched off” (e.g. as described above), with the other resonators “on”. In a second configuration 34, resonators above the symmetry axis are switched off with the remaining resonators “on”. Stored data for positions of the test object corresponding with each “on” resonator can be obtained for each configuration, and a measured impedance spectrum can be obtained for each configuration. The measured impedance spectra can subsequently be compared with the stored data for that state.

The same principle may be applied to all types and cases of symmetry including mirror symmetries and rotational symmetries. The symmetry may be a geometric symmetry, electrical symmetry, magnetic symmetry, or combination thereof.

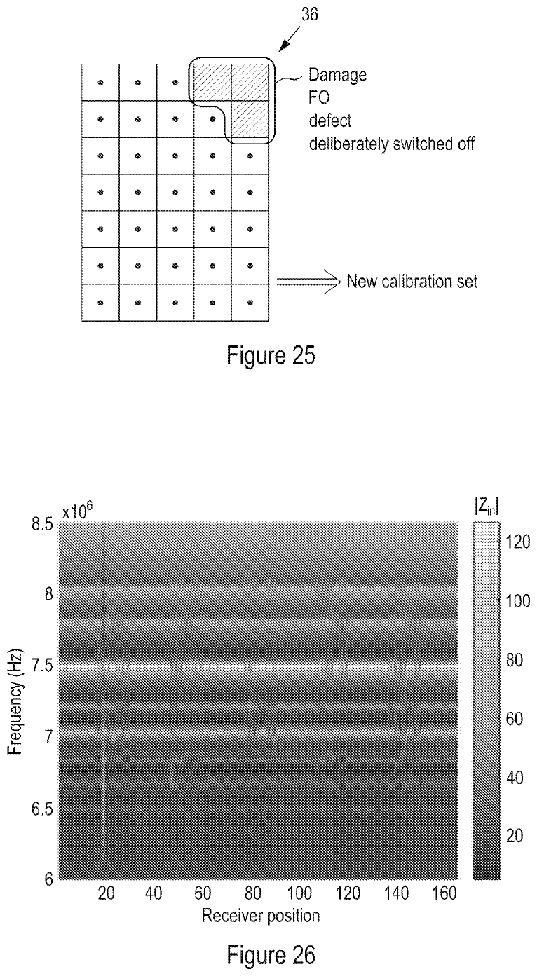

FIG. 25 illustrates an example of a 7×5 array of resonator elements in which some of the elements are excluded from operation. In the example shown in FIG. 25, three of the resonator elements 36 in the top right corner are excluded from operation. For example, the three resonator elements 36 may be damaged, be defective, have a foreign object positioned proximate to them, be deliberately switched-off (to protect foreign objects), or combinations thereof. It may be important to provide stored data (e.g. stored impedance spectra) corresponding to all possible scenarios/permutations of excluded elements in the array. These stored spectra may be obtained using only the non-damaged/non-excluded elements/areas of the array.

It is important to note that it is not necessary for each resonator in the array to be the same, or for the coupling between different elements to be identical. In some embodiments different resonators may have a different nominal resonant frequencies and/or different coupling with nearest neighbours.

The array may comprise a disordered array of substantially identical elements. The ‘array’ may alternatively comprise a substantially disordered array of substantially non-identical elements. The elements may have a high degree of customisability of their position with respect to the other elements.

FIGS. 26 to 32 illustrate results obtained from a particular test case using the methods disclosed herein. In the test case, the accuracy of determining the position of a receiver with respect to a 7×5 (rectangular) array of resonator elements was investigated. The geometric centre of the central element of the array was defined as (x, y)=(0, 0). Each resonator element comprised a 103.75 mm (lattice period along x)×103.75 mm (lattice period along y) tile. For the 7×5 array, 165 locations of the receiver were used to obtain the stored impedance spectra. The 165 locations correspond to centre, (mutual) corner, and (mutual) centre of edge locations of the object relative to the resonator elements of the array. In each case the probe resonator was at position 19, counting upwards in columns from the bottom left (i.e. the probe resonator was in the leftmost column (of resonators), in the second row from the bottom (of resonators).

FIG. 26 shows 165 stored impedance spectra obtained by probing an element of the array, while a receiver is positioned proximate to one of the 165 selected locations (each in turn).

These stored spectra were then compared with a measured input impedance spectrum to determine the position of a receiver/object with respect to the array.

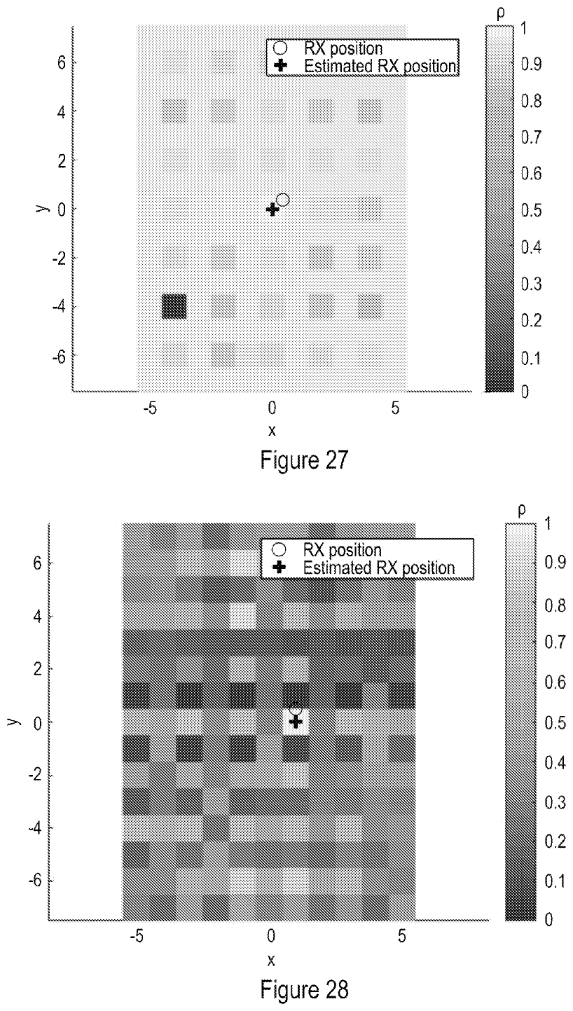

In each of FIGS. 27 to 31, the circle indicates the actual position of the receiver, and the cross indicates the determined position of the receiver from the methods disclosed herein. The colour-mapping represents the correlation between the measured input impedance spectrum and the stored impedance spectrum associated with each of the 165 possible locations of the receiver/object.

FIG. 27 corresponds with the object/receiver being positioned at (x, y)=(20mm, 20mm), which is close to the centre of the centre resonator at (0, 0). The position inferred from the input impedance spectra is correct, in that the location nearest to the actual location has been selected.

FIG. 28 corresponds to the receiver being positioned at (x, y)=(51.9mm, 25mm), which is close to a centre of the edge of the centre tile at (51.9, 0). Again, the position has correctly been inferred from the correlation of the measured spectrum with the stored data.

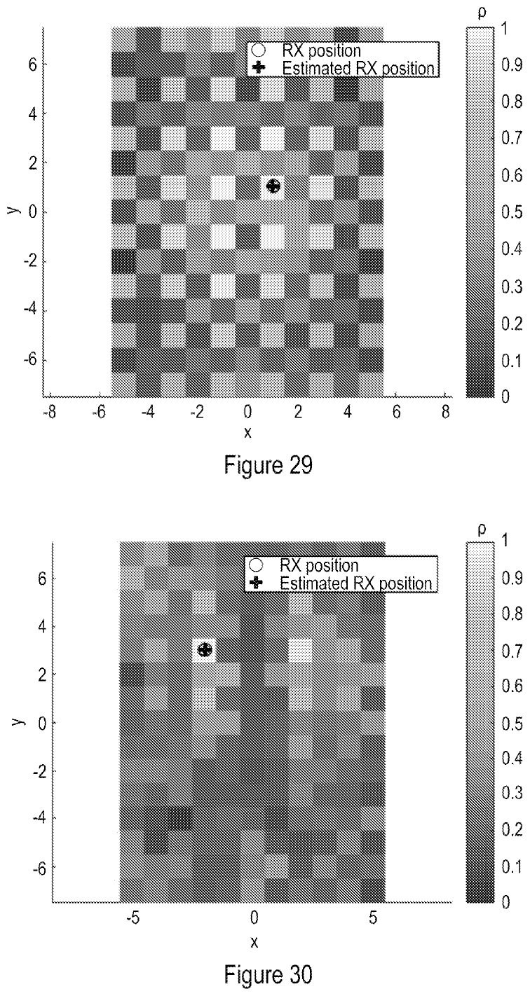

FIG. 29 corresponds to the receiver being positioned at (x, y)=(55mm, 55mm), which is close to a corner of the centre tile at (51.9mm, 51.9mm). Again, the position has correctly been inferred from the correlation of the measured spectrum with the stored data.

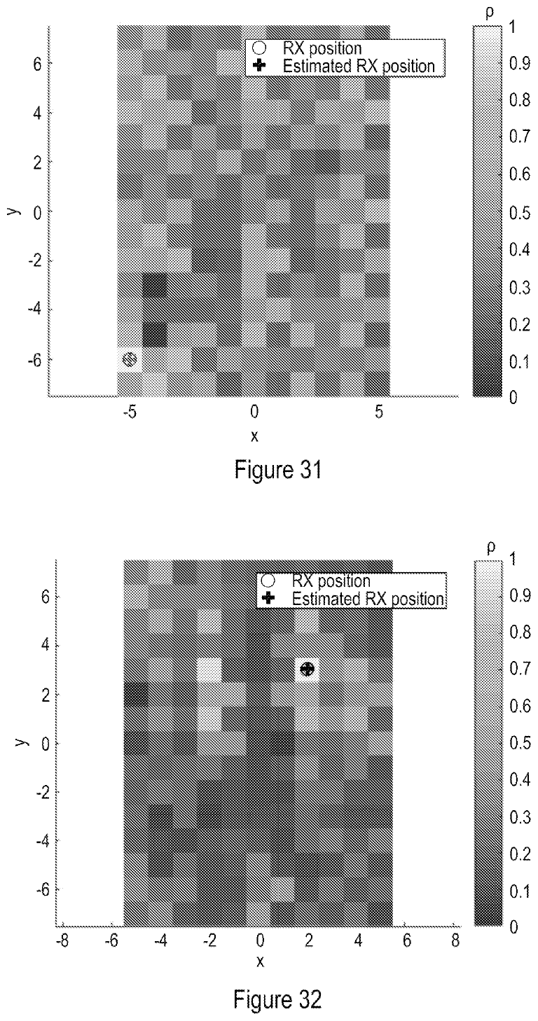

FIGS. 30 to 31 correspond to three additional positions of the receiver, positioned proximate to a centre, edge, or corner of an element of the array which is not the centre element. The circles indicate the actual position of the receiver, and the crosses indicate the determined position of the receiver from the methods disclosed herein. Again, the method correctly identifies the location of the receiver/object.

There is also provided a method for locating a target device (such as a receiver), coupled to an array of resonators. The method comprises conducting a search for the target device by adjusting parameters of the array to vary the distribution of current therein, while monitoring the input impedance of the at least one powered electrical resonator of the array.

In an example embodiment of the method, a process or algorithm may be used to identify the position of one or more receivers of wireless power (and/or data) located above and coupled to a transmitter array for wireless transmission for power (and/or data).

Power may be injected into the transmitter array at one or more elements. For example, power may be injected at a substantially centrally-positioned resonator element. It will be appreciated that power may be injected at a resonator element at any position within the array.

The transmitter array may comprise a plurality of resonator elements, wherein at least adjacent elements may be configured to be mutually electromagnetically coupled. Power and/or data may be propagated through the transmitter array via inter-element coupling. The resonator elements may be configured to allow tuning and/or detuning to and/or from the resonator frequency of other resonator elements in the array. The resonator elements may be configured to have an ON state and an OFF state. The transmitter array may comprise controllable elements such as those described in International Publication No. WO2018/229494.

A communication link may be provided between the transmitter array and the receiver. This may allow the receiver to report its presence (e.g. position and/or coupling to the array) and/or its ID (e.g. a device name) and/or its state (e.g. battery charge availability) to the transmitter array. The communication link between the transmitter array and the receiver may comprise, for example, Bluetooth Low Energy (BLE) and/or a near-field communication protocols (e.g. NFC).

The localisation process may be initiated upon detection of a receiver becoming coupled to the array and/or being positioned proximate the array and/or being translating with respect to the array and/or communication wirelessly with the array via the communication link. In some embodiments, the localisation process may be initiated upon detection of one or more receiver being removed from the array. Determining if the apparatus satisfies any of these conditions may comprise measuring the input impedance of the transmitter array. Measuring the input impedance of the transmitter array may be conducted continuously or periodically (for example, at least once every second or at least once every 10 seconds). When a variation in the input impedance is detected, the localisation method routine may be initiated. A variation in the input impedance may be detected when a change in the input impedance is greater than a input impedance change threshold. The threshold value may be adjusted to account for thermal and/or other fluctuations, measurement error, and environmental parameters. To determine if a change in the input impedance is greater than an input impedance change threshold, the current input impedance measurement is compared with the previous input impedance measurement. The maximum threshold may be periodically updated to account for when a new receiver is detected and/or for when an existing receiver is removed.

The input impedance may be determined by measuring the amplitude and phase of the input current and voltage at an impedance-probing point. Alternatively or additionally, the input impedance may be determined by measuring the incident and reflected voltage wave amplitudes and phases at the impedance-probing point. The impedance-probing point may comprise a probing point of a single resonator of the transmitter array. The impedance-probing point may coincide with a power-injection point.

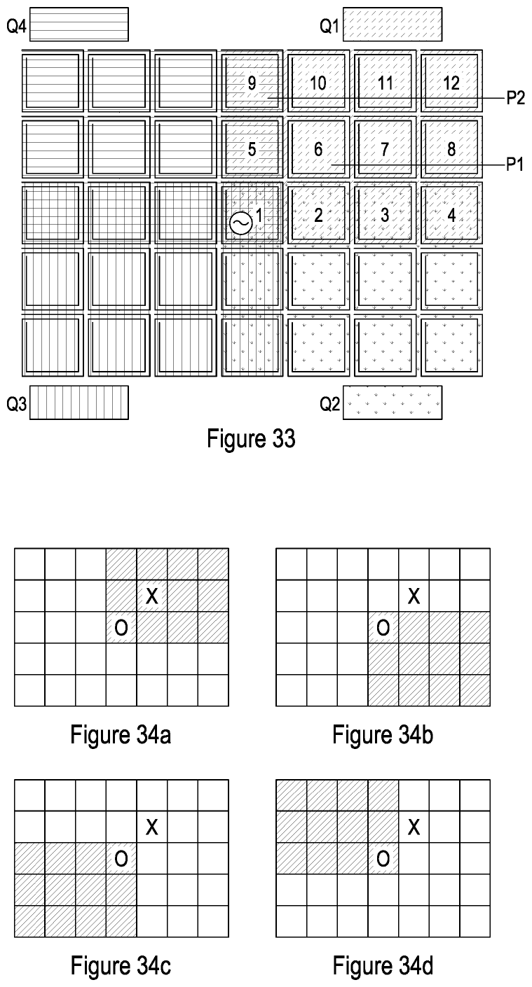

FIG. 33 shows a 7×5 array of transmitter elements, defined in terms of subsets (in this case each subset is approximately a quadrant) Q1-Q4. The array is powered at the resonator labelled no. 1. As an example, one or more receivers may be located at position P1 and/or P2.

FIGS. 34a-d show a 7×5 array of transmitter elements similar or identical to the one shown in FIG. 33. In each of FIGS. 34a-d, the elements comprising a different quadrant are set to be in an ON state, and the other elements are set to the OFF state (or detuned or switched out). In each case, the transmitter array is powered at the resonator element labelled ‘o’, and a receiver is located at position ‘x’. FIGS. 34a-d correspond to each of the quadrant Q1-Q4 in Figures being investigated, respectively.

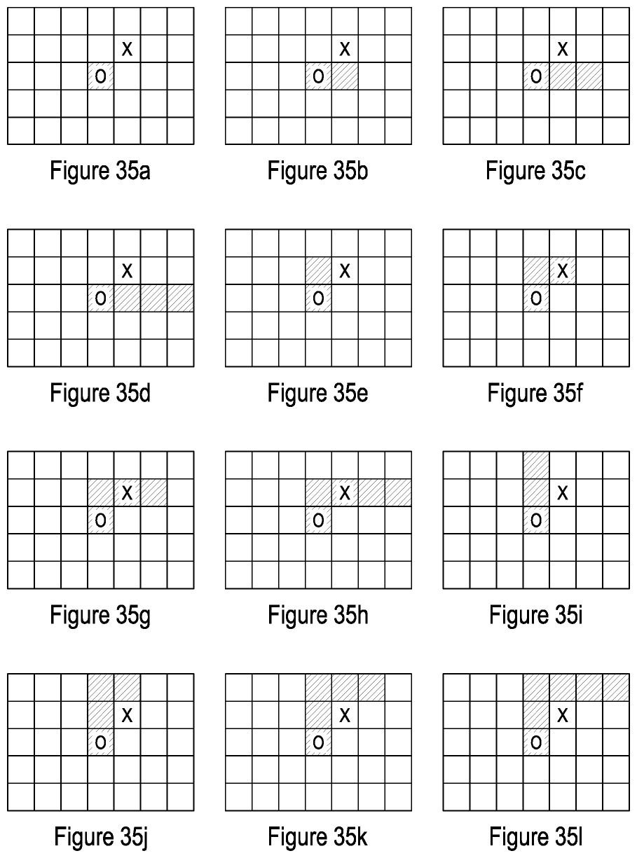

Once the localisation process has been initiated, a first localisation process may proceed as follows (shown in 34a-d). In some embodiments, the first location process may comprise the receiver being localised to one or more quadrants of the array. To determine in which of the four quadrants the receiver is located, one of the quadrants is selected, for example Q1 (e.g. by detuning all elements that are not within quadrant Q1), comprising the elements in grey in FIG. 34a. The input impedance of the selected quadrant is then probed (e.g. at the powered resonator). The measured input impedance in the selected quadrant may then be compared to a predetermined value of the input impedance for the selected (quasi-)quadrant. If the difference between the measured input impedance and a predetermined value of the input impedance exceeds a threshold (which will be the result obtained for FIG. 34a, but not for FIGS. 34b-d), a second localisation process (see FIGS. 35a-1) may be is conducted to localise the receiver to one or more resonator element of that quadrant. The first localisation process is repeated for each of the other three quadrants Q2-Q4.

The first localisation process may be performed using subsets that are not quadrants. For example, the subsets used in the first localisation process may comprise halves, eighths, sixteenths, thirds, or a non-regular/non-uniform grouping of the elements.

As will be understood from the example described above, the term quadrant as used herein encompasses a case where one or more resonator elements of the array lie in two or more ‘quadrants’ (i.e. the quadrant in which a resonator element lies in is potentially non-unique). For example, in the case of a7×5 array, the top-right, bottom-right, bottom-left, and top left quadrants (Q1-Q4, in FIG. 33, and in FIGS. 34a-d, respectively) may be defined as 4×3 arrays. In that case, the central resonator element (resonator No. 1 in FIG. 33 of the 7×5 array, and labelled ‘o’ in FIGS. 34a-d) lies in all four quadrants, ten resonator elements each lie in exactly two quadrants, and 24 resonator elements lie in only one quadrant. This definition may be advantageous because the central resonator element of the 7×5 array may be implemented as both the power injection point and the input impedance probing point for all four quadrants Q1-Q4.

Once the first localisation process has been completed, the second localisation process may proceed as follows. The second localisation process is only conducted for subsets (e.g. quadrants) in which a change in the input impedance has been determined to exceed the relevant threshold. During the second localisation process, the resonators that are not comprised in the current subset may be detuned. Each of the resonator elements of the selected subset may controlled by tuning and detuning (or setting each resonator to either an ON or an OFF state) to produce a plurality of power routes (and/or data routes). Each of the power routes (and/or data routes) may terminate at a different resonator element.

Referring to FIG. 33 and FIGS. 35a-1, in the example of the 7×5 resonator element, wherein each of the quadrants (Q1-Q4) is defined by a 4×3 array, there are twelve unique termination locations (see Q1 which comprises labels 1-12, and FIGS. 35a-1). Each route may be consecutively selected to search for receivers that may be present along routes terminating at different locations. Each route may be obtained by maintaining tuning (e.g. not modifying or leaving in the ON state) the resonator elements that make up that particular route, while detuning (or switching to the OFF state) the other resonator elements in the quadrant (that do not make up the route). The twelve routes with unique terminations locations (in Q1, and in FIGS. 35a-1) are indicated in the Table A below—the power injection point for each route is at the resonator element labelled No. 1 in FIG. 33, and ‘x’ in FIGS. 35a-1.

TABLE A

| | | Resonator elements |
|---|---|---|
| Route No. | FIG. | included in the route |
| 1 | 35a | 1 |
| 2 | 35b | 1, 2 |
| 3 | 35c | 1, 2, 3 |
| 4 | 35d | 1, 2, 3, 4 |
| 5 | 35e | 1, 5 |
| 6 | 35f | 1, 5, 6 |
| 7 | 35g | 1, 5, 6, 7 |
| 8 | 35h | 1, 5, 6, 7, 8 |
| 9 | 35i | 1, 5, 9 |
| 10 | 35j | 1, 5, 9, 10 |
| 11 | 35k | 1, 5, 9, 10, 11 |
| 12 | 35l | 1, 5, 9, 10, 11, 12 |

If a receiver is at position P1 shown in FIG. 33 (and ‘x’ in FIGS. 34a-d and 35a-1), the transmitter will register the receiver being present in Routes Nos. 6, 7, and 8. It may readily be deduced from this that the receiver is at resonator 6, and the shortest route is route number 6. In another example, if a receiver is at position P2 shown in FIG. 33 (not shown in FIGS. 34a-d or 35a-1), the transmitter will register the receiver being present in Routes Nos. 9, 10, 11, and 12.

When powered (and/or fed with data) at the injection point, each route may generate sufficient field above each resonator comprising the route to provide power (and/or data) to a receiver above any of the resonators comprising the route. In some embodiments, a powered the receiver may report receipt of power and/or data via the array to the transmitter (via Bluetooth Low Energy, NFC, in-band, or other communication protocol). The transmitter may record which routes result in reporting of receipt of power/data from the receiver. The search may be deemed complete, for example, when the maximum number of identified devices is reached (if such a limit is specified) or when all transmitter routes have been tested.

For example, assuming that a receiver couples only to the nearest resonator element of the transmitter array (in terms of the x-y distances within the transmitter array), if a receiver is in the position P1, the receiver may be registered in the routes show in FIGS. 35f-h. The nearest terminating resonator element in those routes may be considered to be the position of the receiver.

To avoid any potential ambiguity in the possible receiver positions, the following approaches may be applied. In some embodiments, the transmitter may be configured to cycle through the possible routes shown in Table A above; the receiver may be considered to be located at the nearest terminating position (end resonator element) of the routes in which the receiver is registered. In some embodiments (for example, to determine the position of a receiver placed exactly between two or more resonator elements of the array), the transmitter may be configured to cycle through alternative routes (some of which are shown in Table A above); and knowing the coupling strengths between the receiver and transmitter elements, the system may select the position based on the number of different routes in which the receiver is registered. In some embodiments, the receiver is configured to report its status (e.g. received power, input current, input voltage) to the transmitter array; and the status may be used to select the position from the list of possible receiver positions.

Alternatively or additionally to the above-disclosed method, the method for locating a target device (such as a receiver), coupled to an array of resonators, may comprise conducting a search for the target device by adjusting parameters of the array to vary the distribution of current therein, while monitoring a received power at the target device.

To monitor the received power at the target device, subsets of resonators of the array of resonators may be switched on/off (or tuned/detuned) in turn, and the targets device's response to each of the subset configurations may be monitored. The response of target devices may be communicated to the transmitter array. The target device's response may be delivered to the array via in-band communication channel or external communication channel (i.e. BLE, NFC). The transmitter array may register the device, not through continuous input impedance measurement (as in the above-disclosed method), but through a sequence of dedicated communication messages (some of which may be defined in WPT standards, such as Qi or AirFuel) sent from the target device to the transmitter array. The target device may, for example, communicate a response to the array if the power (or the change in power) that it receives for a particular subset configuration exceeds a power threshold. A response may be sent continuously or periodically. The response may be sent regardless of the power received if the target device is coupled to or positioned proximate at least one of the resonators of the array. The magnitude of the power received may be communicated to the transmitter array. The transmitter array may be configured to determine if the power received exceeds the power threshold. Other information may be communicated between the target device and the transmitter array, such as the charging status of the target device

The method may comprise locating the target resonator by determining which electrical resonator has the best coupling to the target device placed in proximity to the structure.

At least one or each of the electrical resonators may be provided with a current sensor for detecting current flow in the electrical resonator. The current sensor may comprise a Hall sensor.

Locating the target resonator may comprise:
establishing a communication channel between a system controller and the target device;
receiving information from the target device about whether the target device is receiving power from the structure;
conducting the search for the target device by adjusting the parameters of the structure to vary the distribution of current therein, while monitoring the received power at the target device.

Locating the target resonator may comprise monitoring the efficiency of power (or data) transfer from the array to the target device. Monitoring the efficiency of power (or data) transfer may comprise monitoring the efficiency of power (or data) transfer for each of the subset configurations in which the target device is deemed to receive power (or data). The target device may be configured to communicate with the target device in order to determine the transfer efficiency. The subset configuration that results in the highest power- (or data-) transfer efficiency between the array and the target device may be selected to transfer power and/or data from the array to the target device, for example, for a subsequent period of time. The skilled person will appreciate that the actual physical location of the target device with respect to the array may not need to be determined in order to transfer power and/or data efficiently to the target device - only the subset configuration that results in the highest power or data transfer efficiency may need to be determined.

The skilled person will appreciate that the present method may comprise any of the features of the above-disclosed method, wherein monitoring the input impedance of the at least one powered electrical resonator of the array is instead replaced by monitoring the received power at the target device.

Although the some of the detailed examples described herein are based on impedance spectra, it will be understood that the same approach can be applied to time domain measurements.

The expression ‘position of a device’ and similar such expressions used herein do not necessarily refer to a precise x-y coordinate, for example, such expressions may simply refer to the resonator of the array to which the ‘device’ is most strongly coupled. In some embodiments, the ‘position of the device’ may be deemed to be the x-y position of the centroid of one or more resonators to which the device to receive power is most strongly coupled.

The example results shown herein were experimentally-obtained (not obtained from computer simulations). The test cases illustrate that the methods disclosed herein are successful in determining the position of the receiver.

Although a number of examples have been disclosed, it will be understood that other variants are possible, within the scope of the appended claims.

1. A method of determining a position of an object relative to an array of resonator elements for wireless transmission of power by electromagnetic coupling between adjacent resonator elements, wherein the object is inductively coupled to the array, the method comprising:
determining an input signature of the array with the object coupled thereto, measured at a probe resonator of the array; and
determining the position of the object relative to the array with reference to the input signature.

2. The method of claim 1, wherein the input signature comprises an input impedance spectrum, and/or a time domain reflectometry measurement.

3. The method of claim 1 or 2, wherein the determining the position of the object relative to the array is with reference to a comparison between the input signature and stored data obtained from previously measured signatures corresponding with different positions of a test object with respect to the array.

4. The method of claim 3, wherein the comparison comprises comparing the input signature with stored signatures corresponding to different positions of the test object with respect to the array.

5. The method of claim 4, wherein comparing the input signature with stored signatures comprises determining an error or correlation between the input signature and each of the stored signatures.

6. The method of claim 5, wherein determining the error comprises determining a difference value between the input signature and each of the stored signatures.

7. The method of claim 5 or 6, wherein determining the position comprises identifying the position corresponding with a minimum error or maximum correlation.

8. The method of any of claims 3 to 7, wherein determining the position of the object relative to the array with reference to the input signature comprises:
extracting features from the input signature,
and the comparison comprises comparing the features of the input signature with stored features obtained from signatures corresponding to different positions of a test object with respect to the array.

9. The method of claim 8, wherein the features of the input signature comprise an amplitude and/or frequency of at least one of: a local maximum, a global maximum, a local minimum, a global minimum, a point of inflection, and at least one predetermined frequency.

10. The method of any of claims 3 to 9, wherein the test object comprises a resonator configured receive power from the array by inductively coupling with an adjacent resonator of the array.

11. The method of any of claims 3 to 10, wherein the different positions comprise, for each resonator element, a position of the test object that is adjacent to the resonator element.

12. The method of any of claims 3 to 11, wherein the different positions comprise at least one intermediate position between mutually adjacent resonator elements.

13. The method of any preceding claim, wherein determining the position of the object relative to the array with reference to the input signature comprises using a trained neural network to determine the position of the object from the input signature, wherein the trained neural network has been trained using a plurality of signatures for which the position of a test object is known.

14. The method of any preceding claim, wherein at least one resonator element of the array is a controllable resonator that is switchable from an on state to an off state using a control signal.

15. The method of claim 14, wherein each controllable resonator comprises a primary resonator, a secondary resonator inductively coupled to the primary resonator, and an active control component configured to vary the resistance of the secondary resonator in response to the control signal, thereby adjusting the impedance of the primary resonator.

16. The method of any of the preceding claims, wherein the input signature corresponds with a first configuration of the array, the method further comprising:
reconfiguring the array into a second configuration and determining a further signature of the element of the array;
wherein determining the position of the object relative to the array is with reference to both the input signature and the further signature.

17. The method of any preceding claim including the subject matter of claim 2, wherein the previously measured signatures correspond with a plurality of configurations of the array.

18. The method of any preceding claim, wherein the object comprises a plurality of objects, wherein each of the plurality of objects is positioned above a different resonator element of the array.

19. The method of any preceding claim, further comprising, subsequent to determining the position of the object, configuring the array to improve the efficiency of power transfer from a powered resonator element of the array to the object.

20. The method of claim 19, wherein configuring the array to improve the efficiency of power transfer comprises: providing a 1-dimensional waveguide from the powered resonator to a resonator that is adjacent to the object, or turning off a subset of the resonators to suppress one or more standing wave pattern in the array, so as to reduce parasitic losses in resonators that are not participating in power transfer to the receiver.

21. The method of any preceding claim, wherein the probe resonator is positioned to avoid a line of symmetry of the array.

22. Apparatus for inductive wireless power transfer, comprising:
an array of resonators in which adjacent resonators are electromagnetically coupled such that they support inter-element excitation waves propagating through the array;
wherein the array of resonators comprises a probe resonator that includes an impedance measurement module for determining an input signature of the probe resonator, and
further comprising a processor configured to determine the position of an object that is inductively coupled to the array from an signature measured by the impedance measurement module.

23. The apparatus of claim 22, wherein the input signature comprises an input impedance spectrum, and/or a time domain reflectometry measurement.

24. The apparatus of claim 22, further comprising a memory that stores data obtained from previously measured input signatures at the probe resonator corresponding with different positions of a positions of a test object with respect to the array, wherein determining the position comprises comparing the measured signature with the stored data.

25. The apparatus of claim 24, wherein the memory stores signatures corresponding with different positions of the test object with respect to the array, and comparing the input signature with previously measured input signatures comprises determining an error between the input signature and each of the stored signatures.

26. The apparatus of claim 25, wherein determining the error comprises determining a difference value between the input signature and each of the stored signatures.

27. The apparatus of claim 25 or 26, wherein determining the position comprises identifying the position corresponding with a minimum error.

28. The apparatus of any of claims 22 to 27, wherein determining the position of the object relative to the array with reference to the input signature comprises:
extracting features from the input signature,
and the stored data comprises features obtained from signatures corresponding to different positions of a test object with respect to the array, and the comparison comprises comparing the features of the input signature with the features of the stored data.

29. The apparatus of claim 28, wherein the features of the input signature comprise an amplitude and/or frequency of at least one of: a local maximum, a global maximum, a local minimum, a global minimum, a point of inflection, and at least one predetermined frequency.

30. The apparatus of any of claims 22 to 29, wherein the test object comprises a resonator configured to receive power from the array by inductively coupling with an adjacent resonator of the array.

31. The method of any of claims 22 to 30, wherein the different positions comprise, for each resonator element, a position of the test object that is adjacent to the resonator element.

32. The apparatus of any of claims 22 to 31, wherein the different positions comprise at least one intermediate position between mutually adjacent resonator elements.

33. The apparatus of any preceding claim, wherein determining the position of the object relative to the array with reference to the input impedance spectrum comprises using a trained neural network to determine the position of the object from the input signature, wherein the trained neural network has been trained using a plurality of signatures for which the position of a test object is known.

34. The apparatus of any preceding claim, wherein at least one resonator element of the array is a controllable resonator that is switchable from an on state to an off state using a control signal.

35. The apparatus of claim 34, wherein each controllable resonator comprises a primary resonator, a secondary resonator inductively coupled to the primary resonator, and an active control component configured to vary the impedance of the secondary resonator in response to the control signal, thereby adjusting the impedance of the primary resonator.

36. The apparatus of claim 32 or 35, wherein the input impedance spectrum corresponds with a first configuration of the array, and the processor is configured to:
reconfigure the array into a second configuration by providing a control signal to at least one controllable resonator and determine a further input signature of the element of the array;
wherein determining the position of the object relative to the array is with reference to both the input signature and the further input signature.

37. The apparatus of any preceding claim including the features defined by claim 22, wherein the previously measured signatures correspond with a plurality of configurations of the array.

38. The apparatus of any preceding claim, wherein the object comprises a plurality of objects, wherein each of the plurality of objects is positioned above a different resonator element of the array.

39. The apparatus of any preceding claim, wherein the apparatus comprises a powered resonator configured to transfer electrical power to the array for wirelessly powering an object adjacent to the array, and the processor is configured to, after determining the position of the object, configure the array to improve the efficiency of power transfer from a the powered resonator element of the array to the object.

40. The apparatus of claim 39, wherein configuring the array to improve power transfer comprises providing a 1-dimensional waveguide from the powered resonator to a resonator that is adjacent to the object, or turning off a subset of the resonators to suppress one or more standing wave pattern in the array, so as to reduce parasitic losses in resonators that are not participating in power transfer to the receiver..

41. A machine readable non-transitory storage medium, comprising instructions for configuring a processor to perform the method of any of claims 1 to 31.

42. A method for localising a target device coupled to an array of resonators, comprising:
conducting a search for the target device by adjusting parameters of the array to vary the distribution of current therein, while monitoring the input impedance of the at least one powered electrical resonator of the array.

43. The method of claim 42, wherein the method further comprises:
categorising the resonators of the array into a plurality of portions; and
(i) tuning, switching on, and/or connecting all of the resonators in a first subset of the plurality of portions; and
(ii) detuning, switching off, and/or disconnecting all of the resonators that are not in the first subset;
(iii) measuring the input impedance of the array of resonators;
(iv) determining if the measured input impedance differs from a predetermined value of the input impedance;
(v) determining if a target device is proximate to the first portion based on a difference between the measured input impedance and the predetermined value of the input impedance; and
repeating steps (i)-(v) for each of the other subsets of the plurality of portions.

44. The method of claim 43, wherein the each subset comprises a quadrant.

45. The method claim 43 or 44, wherein the method further comprises:
for a subset for which a target device is determined to be proximate thereto,
(i) tuning, switching on, and/or connecting at least one of the resonators in the portion to provide a first route terminating at a first terminating resonator;
(ii) detuning, switching off, and/or disconnecting all of the resonators that are not in the first route;
(iii) measuring the input impedance of the array of resonators;
(iv) determining if the measured input impedance differs from a predetermined value of the input impedance;
(v) determining if a target device is proximate a resonator in the first route based on a difference between the measured input impedance and the predetermined value of the input impedance; and
repeating steps (i)-(v) for at least one route for each possible terminating resonator.

46. A method for localising a target device coupled to an array of resonators, comprising:
conducting a search for the target device by adjusting parameters of the array to vary the distribution of current therein, while monitoring:
(i) a received power at the target device; and/or
(ii) a received data at the target device.

47. The method of claim 46, wherein the target device is configured to send an indication of receipt of power and/or a receipt of data to the array of resonators, and wherein the array of resonators is configured to receive an indication of receipt of power and/or an indication of receipt of data from the target device, wherein the method further comprises:
sending from the target device to the array of resonators an indication of receipt of power and/or an indication of receipt of data.

48. The method of claim 46 or 47, wherein adjusting parameters of the array comprises:
(i) selecting a first subset of the resonators of the array;
(ii) tuning, switching on, and/or connecting all of the resonators in the first subset;
(iii) detuning, switching off, and/or disconnecting all of the resonators that are not in the first subset; and
(iv) repeating steps (i) to (iii) for at least a second subset of the resonators of the array, wherein the second subset is different from the first subset.

49. The method of claim 48, wherein the array of resonators is configured to record if the array has received an indication of receipt of power and/or an indication of receipt of data from the target device for the first subset and/or the second subset, wherein the method comprises:
recording, by the array of resonators, if the array has received an indication of receipt of power and/or an indication of receipt of data from the target device for the first subset and/or the second subset.
